(19) United States
(12) Patent Application Publication
(10) Pub. No.: US 2026/0340374 A1
(43) Pub. Date: Oct. 29, 2026

(54) SYSTEM AND METHOD FOR HIGH PRECISION DIGITAL OPTICAL PROCESSING

(71) Applicant: Danmarks Tekniske Universitet, Kongens Lyngby (DK)

(72) Inventors: Xiansong Meng, Kongens Lyngby (DK); Deming Kong, Kongens Lyngby (DK); Hao Hu, Kongens Lyngby (DK)

(73) Assignee: Danmarks Tekniske Universitet, Kongens Lyngby (DK)

(21) Appl. No.: 19/159,127

(22) PCT Filed: Feb. 26, 2024
(86) PCT No.: PCT/EP2024/054825

§ 371 Date: Aug. 22, 2025

(30) Foreign Application Priority Data
Feb. 24, 2023 (EP) 23158620.7

(51) Int. Cl. G06N 3/067; G02F 1/21

(52) U.S. Cl. CPC G06N 3/0675; G02F 1/212

(57) ABSTRACT

A method of using optical coherence tomography for training a machine learning model includes the steps of illuminating a first sample having a known condition along an illumination path, capturing a first training image of the sample along a first training collection path which is spatially and/or angularly offset from the illumination path by a first training offset, capturing a second training image of the sample along a second training collection path different from the first training collection path for providing a reference image, and training a machine learning model based on the first and second training images and the known condition.

### CROSS-REFERENCE TO RELATED APPLICATIONS

The present application is the U.S. national phase entry of International Patent Application No. PCT/EP2024/054825, filed Feb. 26, 2024, which claims priority to European Patent Application No. 23158620.7, filed Feb. 24, 2023, the entire contents of both are hereby incorporated by reference.

### TECHNICAL FIELD

This disclosure relates to systems and methods for half-digital and full-digital high precision digital optical processing.

### BACKGROUND

We stand at the dawn of an intelligent era. Powered by deep learning, machines can learn some specific tasks so well that it outperforms humans (e.g. Google AlphaGo). Deep learning architecture scales in complexity and craves computing power to address massive data, mainly for matrix-vector multiplications (MVMs). This has given rise to domain-specific hardware accelerators (e.g, Google's tensor processing unit (TPU) with advanced parallelism for energy efficiency and low latency. However, microelectronics are encountering fundamental bottlenecks on speed, energy consumption, heating, and interconnect delay, which can no longer be resolved by scaling.

A typical neural network, either optical or analogue, contains linear and nonlinear operations. Linear operations include the convolutional and fully connected layers. Nonlinear operations include the activation and softmax layers. Most of the computation time is spent on the linear layers, up to about 90%. Therefore, current artificial intelligence (AI) or neural network processors are mainly designed to optimize the linear operation process, that is, matrix multiplication, for example. One of the state-of-the-art AI processors is the Google's TPU. The core component of the Google's TPU is the matrix multiplication unit, which also consumes most of the computation time and power consumption. Moreover, matrix multiplication units are in essence multipliers, adders and shifters, so that the computation speed is limited by the electrical clock rate, resulting in a computing speed limit of a few GHz. When the clock speed is accelerated, it may lead to timing violations and power consumption spikes.

A matrix multiplication refers to multiplications between digital signals, and more generally to the family of arithmetic logic circuits. A digital multiplication may be performed by digital circuits following digital multiplier architectures such as the Baugh-Wooley algorithm, Wallace trees, or Dadda multipliers. Unfortunately, digital multipliers implemented with digital circuits quickly requires complex architectures which are both energy costly and speed inefficient. These architectures impose a limit in the processing speed of digital multiplications.

In this context, photonic integrated circuits (PICs) are free from the obstacles described above. First, PICs are more efficient for data transport without charging/discharging metal wires. Second, PICs can utilize optical multiplexing and achieve a large bandwidth density over hundreds of Terabit/s on a single chip. Third, light propagating in PICs features a much lower energy consumption concerning the number of operations. PICs are also compatible with mature CMOS technology for massive integration and production.

PIC-based ONNs are physical implementations of an analogue neural network (ANN) using ultrafast optical integrated components. PIC-based ONNs demonstrations have shown great potential to surpass their digital microelectronic counterparts in calculating speed (>10³), energy consumption (>10²), and computing density (>10²). Despite these great potentials, there are great scientific and technical challenges for ONNs. First and foremost, these ONNs are all based on analogue computing architectures (analogue ONNs) where the input data and weight are carried on the light intensities. There is one major scientific challenge for this analogue computing architecture: insufficient signal-to-noise ratio due to accumulated noise and crosstalk in the system. As a consequence, the intensity of the optical signals is usually limited to a precision of around 4 bits at desired high speed. Instead, a 16-bit calculation precision is practically required for reasonable training convergence and many demanding convolutional neural network (CNN) applications such as autonomous driving, high-definition image processing, and 3D computer vision.

Second, the analogue ONN are also incompatible with microelectronics so extra expensive, high-resolution and energy consuming data processing is required, such as digital-to-analogue conversion (DAC) and/or analogue-to-digital conversion (ADC). Therefore, breakthrough technologies are needed to solve challenges in ONN, including calculation precision, compatibility with microelectronics.

### SUMMARY

Thus, there exists a need for an optical neural network that could use a digital hardware architecture that goes beyond the state-of-the-art analogue ONNs. As disclosed here, in embodiments, this can be achieved in one aspect by a digital optical computing processing unit configured to perform analogue-digital convolutions by processing at least a first and a second electrical digital signal and a first optical signal comprising at least two wavelengths. In embodiments, the digital optical computing processing unit may comprise a first waveguide for carrying the first optical signal; a light source configured to deliver the first optical signal comprising at least two wavelengths to the first waveguide; at least a first and a second electrical-to-optical transducer arranged in series and comprised in the first waveguide, configured to be biased by at least a first and a second weight, wherein the at least first and second electrical digital signals modulate the first optical signal in the at least first and second electrical-to-optical transducers, respectively, and wherein the first electrical-to-optical transducer is configured to modulate a first wavelength and the second electrical-to-optical transducer is configured to modulate a second wavelength; and a first optical-to-electrical transducer arranged at a first output of the first waveguide, and wherein the first optical-to-electrical transducer is configured to output a first electrical output signal based on the first optical signal.

In embodiments, the digital optical computing processing unit may comprise an optical calculation unit that can comprise a first waveguide for carrying the first optical signal; at least a first and a second electrical-to-optical transducer arranged in series and comprised in the first waveguide, configured to be biased by at least a first and a second weight, wherein the at least first and second electrical digital signals modulate the first optical signal in the at least first and second electrical-to-optical transducers, respectively, and wherein the first electrical-to-optical transducer is configured to modulate a first wavelength and the second electrical-to-optical transducer is configured to modulate a second wavelength. The optical calculation unit may comprise at least one optical device and/or at least one electrical-to-optical device that would perform analogue-digital convolutions.

The first and second electrical-to-optical transducers are configured to modulate the first optical signal with the at least first and second electrical digital signals, therefore enabling the digital optical computing processing unit to process calculations with electrical digital signals instead of electrical analogue signals. In embodiments, electrical digital signals are more robust to noise than analogue signals. Therefore, robustness to signal-to-noise ratio is improved compared to an optical processing unit that may use electrical analogue signals. By using electrical digital signals, the first electrical output may be a first electrical digital output signal, which can be easier to detect, process and adjudicate than an analogue signal. Moreover, by using electrical digital signals as electrical digital signal inputs, the resolution of the analogue-to-digital converter that would be arranged after the first optical-to-electrical transducer would be released by a significant amount of bits, compared with the prior art. By eliminating the need for a high-speed digital-to-analogue converter at the input, the digital optical processing unit reduces costs, saves energy and simplifies system complexity.

The at least first and second electrical-to-optical transducers can be biased or loaded by a first and a second weight, which may give a possibility of multiplying the at least first and second electrical digital signals with the at least first and second weights, respectively. The first optical signal is then being modulated on each wavelength by electrical digital signals being a result of several multiplications between the at least first and second electrical digital signals and the at least first and second weights in the at least first and second electrical-to-optical transducers arranged on the first waveguide. The first optical-to-electrical transducer is then configured to output a first electrical output signal based on the first optical signal.

In embodiments, the first optical-to-electrical transducer may be wavelength-independent. Therefore, the first electrical output comprises a sum of the several multiplications between the at least first and second electrical digital signals and the at least first and second weights, respectively, which can be defined as a convolution operation. The digital optical processing unit is configured to process convolution operation between digital signals and weights, wherein weights can be either analogue signals or digital signals that can be converted to analogue signals.

FIG. 1A-B show schematic views of an embodiment of the digital optical computing processing unit configured to perform analogue-digital convolutions. A first light source, here a multi-wavelength light source is configured to generate a first optical signal comprising at least two wavelengths, and feed this first optical signal into a first waveguide. The first waveguide comprises 9 electrical-to-optical transducers, connected in series, and more specifically in this embodiment, 9 micro-ring resonators. Each of the micro-ring resonators are biased by a weight, and each of the micro-ring resonators are configured to modulate the first optical signal, each one on a different wavelength with electrical digital signals, which in this embodiment, has an 8-bit precision and represents data from an image. The electrical digital signals are digital representations of the data input to be processed by the digital optical computing processing unit. In FIG. 1A, the data input to be processed is data from an image, in embodiments, information contained in at least one pixel. The electrical digital signals are encoding the data input in a form of a binary word. For instance, and as shown in FIG. 1A, D₁ is a first electrical digital signal, which is a digital representation of the decimal number “39” in a form of a binary word with a length of 8-bit, where “39” may represent the intensity of a corresponding pixel from the image, since the image is in a grayscale format. As shown in FIG. 1A, the decimal number “39” is then coded or encoded within a binary word “00100111” which is equal to “39”. The person skilled in the art would understand that any other digital representations can be achieved by increasing the number of bits within the binary word, or by reducing the number of bits within the binary word, depending on the resolution that the user of the digital optical computing processing unit wants to achieve. All the wavelengths, namely λ₁-λ₂- . . . -λ₉, are then summed up in a first optical-to-electrical transducer, specifically in this embodiment, a photodetector, arranged at a first output of the first waveguide. The first electrical signal based on the first optical signal is a multi-level signal due to the 9 wavelengths summed up at each symbol period. As shown in FIG. 1B, this multi-level signal is then converted to a binary signal, which represents the convolution result 30 between a matrix comprising 9 electrical digital signals, namely D₁-Dₓ- . . . -D₉ and a kernel matrix comprising 9 weights, namely W₁₁-W_{xy}- . . . -W₃₃. The digital optical processing unit may compute convolutions faster and may consume less power than the electrical computing scheme. This is due to the convolution being performed in the optical domain rather than in the electrical domain. By performing the convolution operation with digital electrical signal, a better robustness to noise is achieved compared to analogue counterparts, such as optical neural networks using analogue signals as input signals.

In another aspect, the present disclosure relates to a digital optical computing processing unit configured to perform analogue-digital continuous convolutions by processing at least a first, a second and a third electrical digital signal and a first optical signal comprising at least two wavelengths. The digital optical computing processing unit may comprise a first waveguide; a light source configured to deliver a first optical signal comprising at least two wavelengths to the first waveguide; a primary electrical-to-optical transducer comprised in the first waveguide, wherein the first optical signal is modulated by the at least first electrical digital signal in the primary electrical-to-optical transducer; at least a first and a second electrical-to-optical transducer arranged in series and comprised in the first waveguide, and further arranged in series with the primary electrical-to-optical transducer, wherein the at least first and second electrical-to-optical transducer are configured to be biased or modulated or loaded by at least a first and a second weight, and wherein the at least first and second electrical digital signals modulate the first optical signal in the at least first and second electrical-to-optical transducers, respectively, and wherein the first electrical-to-optical transducer is configured to modulate a first wavelength and the second electrical-to-optical transducer is configured to modulate a second wavelength; a first waveguide portion configured to disperse the first optical signal or to introduce a wavelength-dependent time delay in the first optical signal, wherein the first waveguide portion can be comprised in the first waveguide and arranged before the at least first and second electrical-to-optical transducers; a first optical-to-electrical transducer arranged at a first output of the first waveguide, and wherein the first optical-to-electrical transducer is configured to output a first electrical output signal based on the first optical signal.

As would be apparent to a person skilled in the art, the digital optical computing processing unit configured to perform analogue-digital continuous convolutions may comprise the same features than the digital optical computing processing unit configured to perform analogue-digital convolutions as described herein. At least one difference can be the first waveguide portion which can be configured to disperse the first optical signal or to introduce a wavelength-dependent time delay in the first optical signal, thereby enabling the digital optical computing processing unit to be configured to perform continuous convolutions between analogue and digital signals.

By having a first waveguide portion that may be configured to disperse the first optical signal or to introduce a wavelength-dependent time delay in the first optical signal, wherein the first waveguide portion is comprised in the first waveguide and arranged before the at least first and second electrical-to-optical transducers, the at least two wavelengths comprised in the first optical signal are then dispersed or delayed in time by any other known methods, thereby delayed in time with each other. Before being delayed in time with each other, the at least two wavelengths are both modulated by the at least first electrical digital signal with the primary electrical-to-optical transducer. The at least two wavelengths are then modulated by the same electrical digital signal, i.e. the at least first electrical digital signal, and can be additionally modulated by the at least second and third electrical digital signals within the at least first and second electrical-to-optical transducers, on a first and a second wavelength, respectively. The digital optical computing processing unit configured to perform analogue-digital continuous convolutions can then enable a time-delayed interleaving technique. The time-delayed interleaving technique may allow a continuous processing of data on the at least two wavelengths. By “time-delayed interleaving technique”, it can be understood as time, wavelength and/or spatial dimensions are interleaved. In embodiments, this maximizes the processing speed of the digital optical processing unit, thereby enabling more data to be processed in a given amount of time, or more convolutions between analogue and digital or digital and digital signals to be performed.

FIG. 2 shows a schematic view of an embodiment of the digital optical computing processing unit configured to perform analogue-digital continuous convolutions. A light source, here a multi-wavelength light source is configured to generate a first optical signal comprising at least two wavelengths, namely λ₁-λ₂- . . . -λ₉, and feed this first optical signal into a first waveguide. The first waveguide comprises; a primary electrical-to-optical transducer, namely a Mach-Zehnder modulator, in series with 9 electrical-to-optical transducers, connected in series, and more specifically in this embodiment, 9 micro-ring resonators. The Mach-Zehnder modulator is configured to modulate the first optical signal with at least a first electrical digital signals, namely d_{j,k}, where j and k are dimensions of a matrix comprising j*k electrical digital signals. The at least two wavelengths are then passing through a first waveguide portion, namely a dispersive waveguide, configured to disperse the first optical signal, therefore generating a time delay between each of the wavelengths comprised in the first optical signal. Each of the wavelengths are then further modulated by a weight matrix, namely w_{i,j}, where i and j are dimensions of a matrix comprising i*j weights. All the wavelengths are then summed up in a first optical-to-electrical transducer, specifically in this embodiment, a photodetector, arranged at a first output of the first waveguide. The first electrical signal based on the first optical signal is a multi-level signal due to the 9 wavelengths summed up at each symbol period. This multi-level signal is then converted to a binary signal, which represents the convolution result between the matrix d_{j,k} and the matrix w_{i,j}. In embodiments, this digital optical computing processing unit can process more convolution in a faster way by using both a primary electrical-to-optical transducer, such as a Mach-Zehnder, and high-speed modulation inputs of micro-ring resonators, such as a different convolution between two sub-matrixes can be performed at each symbol period of the system. By using the high-speed modulation inputs of the micro-ring resonators, different weights can also be applied at each symbol period of the system, which makes this digital optical computing processing unit adapted for processing convolution where kernel matrixes containing weights may be different when convolving it with the data from the same source.

In a third aspect, the present disclosure relates to a digital optical computing processing unit configured to perform digital-digital multiplications by processing at least a multiplier and a multiplicand, wherein the multiplicand may comprise at least a first electrical digital signal and the multiplier can comprise at least a second and a third electrical digital signal. In embodiments, the digital optical computing processing unit may comprise a first waveguide; a light source configured to deliver a first optical signal comprising at least two wavelengths to the first waveguide; a primary electrical-to-optical transducer comprised in the first waveguide, wherein the first optical signal can be modulated by the at least first electrical digital signal in the primary electrical-to-optical transducer; at least a first and a second electrical-to-optical transducer arranged in series and comprised in the first waveguide, and further arranged in series with the primary electrical-to-optical transducer, and wherein the at least second and third electrical digital signals modulate the first optical signal in the at least first and second electrical-to-optical transducers, respectively, and wherein the first electrical-to-optical transducer is configured to modulate a first wavelength and the second electrical-to-optical transducer is configured to modulate a second wavelength; a first waveguide portion configured to disperse the first optical signal or introduce a wavelength-dependent time delay in the first optical signal, wherein the first waveguide portion may be comprised in the first waveguide and arranged after the at least first and second electrical-to-optical transducers; a first optical-to-electrical transducer arranged at a first output of the first waveguide, and wherein the first optical-to-electrical transducer can be configured to output a first electrical output signal based on the first optical signal.

As would be apparent to a person skilled in the art, the digital optical computing processing unit configured to perform digital-digital multiplications may comprise the same features than the digital optical computing configured to perform analogue-digital continuous convolutions as described herein. In embodiments, at least one difference is that the first waveguide portion which is configured to disperse the first optical signal or to introduce a wavelength-dependent time delay in the first optical signal is arranged after the at least first and second electrical-to-optical transducers. This enables a digital multiplication between the at least first with the at least second and third electrical digital signals. In embodiments, in a use case, the at least second and third electrical digital signals are elements and/or symbols of a secondary electrical digital signal. The digital multiplication as referred herein is the digital multiplication between the at least first electrical digital signal and the secondary electrical digital signal.

“digital-digital multiplication(s)” as defined herein refers to a multiplication between two digital numbers, in embodiments, two binary numbers, or two multi-level digital signals/numbers. In embodiments, the multi-level digital signals may allow more data per symbol, therefore allowing a multiplication between two numbers with less symbols to be processed by the digital optical processing unit.

The digital multiplication performed by the digital optical computing processing unit configured to perform digital-digital multiplications outperforms the digital multiplier architectures since it is desirable using features of electrical-to-optical transducers and/or photonic circuits in order to perform digital-digital multiplications. By using at least one wavelength in the first optical signal and a wavelength-independent electrical-to-optical transducer, in combination with wavelength-dependent electrical-to-optical transducers and delays, combined with a wavelength-independent optical-to-electrical transducer, the first optical signal can be independently modulated on each of the at least one wavelength, with a time delay between the wavelengths generated by the first waveguide portion. In embodiments, this architecture can reproduce the well-known method of multiplying two digital words, where the two digital words may be binary numbers. FIG. 3A-B show an illustration of a multiplication between two binary words, namely “0110” and “1011”, where the first binary word “0110” needs to be multiplied by each of the symbol or bit of the second binary word “1011”, while each multiplication results need to be shifted by one symbol or bit with the previous one. By summing everything, a binary word can be obtained which represents the result of the multiplication between the two binary words. In embodiments, each of the multiplications between the first binary word and each of the symbol or bit of the second binary word can be performed on each wavelength, as shown in FIG. 3B. In embodiments, the sum of all of these multiplications can be performed by the first optical-to-electrical transducer, which may be wavelength-independent.

FIG. 13 shows a schematic view of an embodiment of the digital optical processing unit. The digital optical processing unit comprises optical devices such as a light source and an optical calculation unit. The light source, as described herein, can be configured to generate a first optical signal comprising at least two wavelengths. The optical calculation unit can be configured to convert the at least first and second electrical digital signals into at least a first and a second optical signals. In embodiments, the optical calculation unit can be configured to process the digital signal inputs, which may be the at least first and second electrical digital signals, with the weight control signals, which can be the at least first and second weights. The optical calculation unit may comprise at least two electrical-to-optical conversion units. The at least two electrical-to-optical conversion units may comprise the at least first and second electrical-to-optical transducers. The optical calculation unit may comprise the first waveguide, the at least first and second electrical-to-optical transducers configured to be biased by the at least first and second weight, and/or the primary electrical-to-optical transducer. The digital optical processing unit further comprises a signal post-processing unit, wherein the signal post-processing unit comprises at least one analogue-to-digital converter (ADC), at least one multiplier and at least one full-adder. A shift circuit can be any combination of electrical delays, thereby shifting binary data either to the left or to the right. Shift circuits can come in two types: serial-in/serial-out (SISO) and serial-in/parallel-out (SIPO). In SISO circuits, binary data is shifted in serially (bit by bit) and comes out in the same manner. In SIPO circuits, binary data is shifted in serially but comes out in parallel (all bits at once). These circuits may use shift registers, which may comprise flip-flops connected in series. A clock signal can determine when binary data is shifted, and the direction of shifting (left or right) can be controlled by at least one shift control input. It should be noted that the FIG. 13 may or may not be drawn to scale and that elements of similar structures or functions are represented by like reference numerals throughout the figures. It should also be noted that FIG. 13 is intended to facilitate the description of the embodiments. FIG. 13 is not intended as an exhaustive description of the present disclosure or as a limitation on the scope of the present disclosure.

In one aspect, the present disclosure further relates to a method for a hybrid optical-electrical convolution between an input data matrix of size i×j and kernel matrix of size i×j comprising the steps of providing an optical signal having i×j different optical carriers, such as i×j different wavelengths; modulating the optical signal with i×j digital data signals, such that an nth of the i×j optical carriers is modulated with an nth of the i×j digital data signals, wherein the i×j digital data signals are a digital representation of i×j elements of the input data matrix; modulating the optical signal with the kernel matrix such that the kernel matrix applies weights on the i×j optical carriers; summing the i×j optical carriers in a wavelength-independent optical-to-electrical transducer on a per symbol level thereby generating an electrical output signal, wherein the electrical output signal represents the convolution between the input data matrix and the kernel matrix.

In another aspect, the present disclosure further relates to a method for a hybrid optical-electrical convolution between an input data matrix of size i×j and kernel matrix of size i×j comprising the steps of providing an optical signal having i×j different optical carriers, such as i×j different wavelengths; modulating the optical signal with i×j digital data signals, wherein the i×j digital data signals are a digital representation of the i×j elements of the input data matrix, and such that each of the i×j optical carriers is modulated with the i×j digital data signals, thereby obtaining i×j optical data signals; providing a time delay between the i×j optical data signals, such that each of the i×j optical data signals are delayed in time between each other; modulating the i×j optical data signals with the kernel matrix such that an nth element of the kernel matrix applies a nth weight on a nth of the i×j optical carriers; summing the i×j optical carriers in a wavelength-independent optical-to-electrical transducer on a per symbol level thereby generating an electrical output signal, wherein the electrical output signal represents the convolution between the input data matrix and the kernel matrix.

In one aspect, the present disclosure further relates to a method for hybrid optical-electrical multiplication of a first digital signal comprising j symbols with a second digital signal comprising k symbols, comprising the steps of providing an optical signal having i different optical carriers, such as i different wavelengths and wherein i is larger or equal than j, and wherein j is larger than or equal to k; modulating the optical signal with the first digital signal, such that each of the i optical carriers is modulated with the first digital signal, thereby defining i optical digital signals; modulating each of the i optical digital signals with a nth of the k symbols on a nth of the i optical carriers; providing a time delay between the i optical digital signals, such that each of the i optical digital signals are separated in time; summing the i optical carriers in a wavelength-independent optical-to-electrical transducer on a per symbol level thereby generating an electrical output signal, wherein the electrical output signal represents the multiplication between the first digital signal and the second digital signal.

As disclosed herein, convolution may refer to an operation between two matrices wherein each of the elements in the same position of the two matrices are multiplied and all the multiplications are summed.

The digital optical computing processing units disclosed herein may be configured to carry out any of the presently disclosed convolution and multiplication methods. Likewise the presently disclosed convolution and multiplication methods may comprise any of the features of the presently disclosed digital optical computing processing units.

In the present disclosure, electrical digital signals may refer to digital binary words. The person skilled in the art would understand that the electrical digital signals can represent inputs to the digital optical computing processing units and the methods, as disclosed herein. The inputs can be encoded into digital signals, thereby encoded into digital binary words or digital vectors. As described herein, analogue signals are fundamentally vulnerable to noise and crosstalk. By using electrical digital signals, a better performance against noise and a higher calculation precision can be achieved, while releasing constraints on the architecture, such as high-speed, high-level digital-to-analogue converters that are used in the analogue optical computing systems.

### DESCRIPTION OF THE DRAWINGS

In the following embodiment and examples will be described in greater detail with reference to the accompanying drawings:

FIG. 1A shows a schematic view of an embodiment of the digital optical computing processing unit configured to perform analogue-digital convolutions,

FIG. 1B shows another schematic view of an embodiment of the digital optical computing processing unit configured to perform analogue-digital convolutions,

FIG. 2 shows a schematic view of an embodiment of the digital optical computing processing unit configured to perform analogue-digital continuous convolutions,

FIG. 3A shows an illustration an example of a multiplication between two binary numbers,

FIG. 3B shows another illustration of an example of a multiplication between two binary numbers,

FIG. 3C shows a schematic view of an embodiment of the digital optical computing processing unit configured to perform digital-digital multiplication,

FIG. 4A shows a schematic view of an embodiment of a micro-ring resonator,

FIG. 4B shows a graph illustrating a micro-ring resonator transmission curve having a given length of the ring,

FIG. 4C shows a graph illustrating a micro-ring resonator transmission curves with different biases,

FIG. 4D shows a graph illustrating a micro-ring resonator transmission curves with transmission loss at a given wavelength,

FIG. 4E shows a graph illustrating a residual power after the micro-ring resonator at the given wavelength for different bias voltages,

FIG. 5A shows a schematic view of an embodiment of a micro-ring resonator,

FIG. 5B shows a graph illustrating the resulting optical amplitude of an optical signal being modulated by a micro-ring resonator by an electrical digital signal having a peak-peak amplitude of Vpp,

FIG. 5C shows a graph illustrating the resulting optical amplitude of an optical signal being modulated by a micro-ring resonator when W has a first positive value,

FIG. 5D shows another graph illustrating the resulting optical amplitude of an optical signal being modulated by a micro-ring resonator when W has a first positive value,

FIG. 5E shows a graph illustrating the resulting optical amplitude of an optical signal being modulated by a micro-ring resonator when W has a second positive value,

FIG. 5F shows another graph illustrating the resulting optical amplitude of an optical signal being modulated by a micro-ring resonator when W has a second positive value,

FIG. 5G shows a graph illustrating the resulting optical amplitude of an optical signal being modulated by a micro-ring resonator when W has a negative value,

FIG. 5H shows another graph illustrating the resulting optical amplitude of an optical signal being modulated by a micro-ring resonator when W has a negative value,

FIG. 6A shows a drawing of an embodiment of a digital optical processing unit with parallel waveguides,

FIG. 6B shows another drawing of an embodiment of a digital optical processing unit with parallel waveguides,

FIG. 6C shows another drawing of an embodiment of a digital optical processing unit with parallel waveguides,

FIG. 7 shows a schematic view of an embodiment of the digital optical processing unit where the at least first, second and third electrical digital signals are modulated by a carrier wave,

FIG. 8A shows a graph representing a statistical summary of correlation between signal error rate (SER) and signal to noise ratio (SNR), for a PAM-16 modulation scheme, a QAM-16 modulation scheme and an analogue scheme,

FIG. 8B shows a graph representing a statistical summary of correlation between root-mean square error (RMSE) and signal to noise ratio (SNR), for a PAM-16 modulation scheme, a QAM-16 modulation scheme and an analogue scheme,

FIG. 9A shown an example of the LUT working principle as used in the disclosed digital optical processing unit,

FIG. 9B shown another example of the LUT working principle as used in the disclosed digital optical processing unit,

FIG. 9C shown another example of the LUT working principle as used in the disclosed digital optical processing unit,

FIG. 9D shown another example of the LUT working principle as used in the disclosed digital optical processing unit,

FIG. 9E shown another example of the LUT working principle as used in the disclosed digital optical processing unit,

FIG. 9F shown another example of the LUT working principle as used in the disclosed digital optical processing unit,

FIG. 9G shown another example of the LUT working principle as used in the disclosed digital optical processing unit,

FIG. 9H shown another example of the LUT working principle as used in the disclosed digital optical processing unit,

FIG. 9I shown another example of the LUT working principle as used in the disclosed digital optical processing unit,

FIG. 9J shown another example of the LUT working principle as used in the disclosed digital optical processing unit,

FIG. 9K shown another example of the LUT working principle as used in the disclosed digital optical processing unit,

FIG. 9L shown another example of the LUT working principle as used in the disclosed digital optical processing unit,

FIG. 10 shows a schematic view of an embodiment of the digital optical computing processing unit configured to perform analogue-digital continuous convolutions,

FIG. 11A shows a drawing of an embodiment of a digital optical processing unit with parallel waveguides,

FIG. 11B shows a schematic view of an embodiment of a digital optical processing unit with parallel waveguides,

FIG. 12A shows a modified national institute of standards and technology (MNIST) dataset validation with the digital optical processing unit,

FIG. 12B show another modified national institute of standards and technology (MNIST) dataset validation with the digital optical processing unit,

FIG. 12C show another modified national institute of standards and technology (MNIST) dataset validation with the digital optical processing unit,

FIG. 12D show another modified national institute of standards and technology (MNIST) dataset validation with the digital optical processing unit,

FIG. 12E show another modified national institute of standards and technology (MNIST) dataset validation with the digital optical processing unit,

FIG. 12F show another modified national institute of standards and technology (MNIST) dataset validation with the digital optical processing unit,

FIG. 12G show another modified national institute of standards and technology (MNIST) dataset validation with the digital optical processing unit,

FIG. 13 shows a schematic view of an embodiment of the digital optical processing unit.

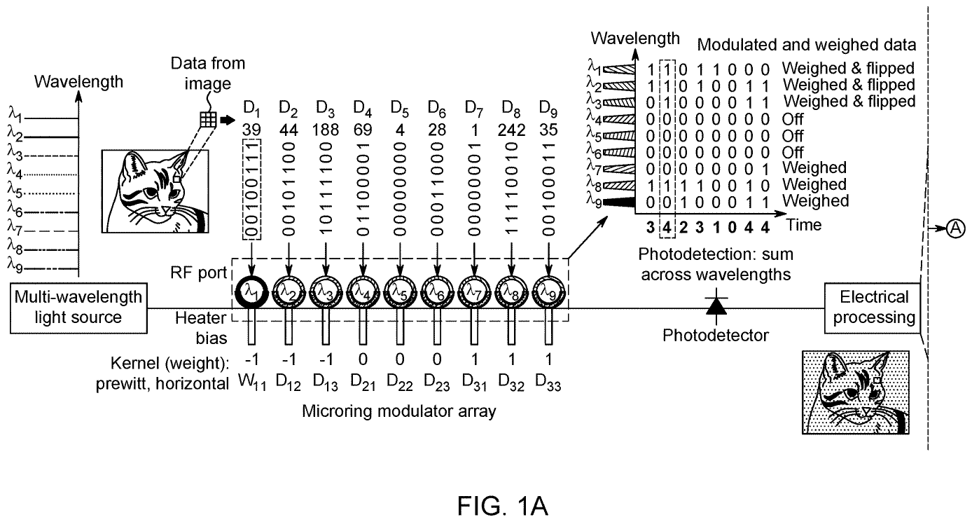

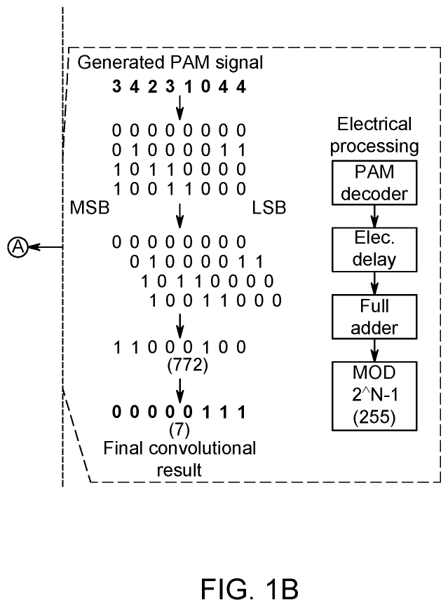

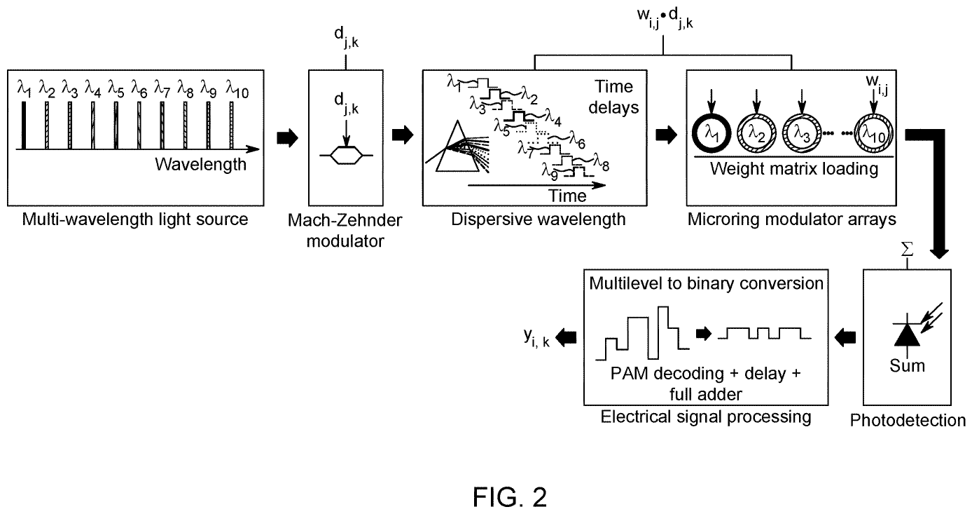

### DETAILED DESCRIPTION

The first electrical output signal is a first electrical digital output signal. The first electrical digital output signal can be a multi-level digital output signal. The first electrical digital output may be generated by the first optical-to-electrical transducer, based on the first optical signal. Since the first optical signal can be modulated by at least a first and a second electrical digital signal, the first electrical output signal may be desirably digital. By having the first electrical output signal being digital, an easier processing of the first electrical output signal can be achieved with common reshaping, filtering or equalizing techniques known in the art. These techniques can be achieved by a digital signal processing system. Digital signal processing (DSP) systems may include the following features:
Equalizers: compensate for channel impairments in high-speed communication systems, such as distortion and attenuation.
Digital filters: remove unwanted noise from signals and to extract specific frequency components.
Clock and data recovery systems: extract the clock signal from a high-speed data stream, allowing data to be accurately sampled and processed.
Signal generators: generate high-frequency signals that can be used for testing and calibration of high-speed systems.
Time-domain reflectometers: locate faults in high-speed transmission lines by measuring the reflection of signals at the point of discontinuity.
Modulation and demodulation systems: modulate data onto high-frequency carrier signals and to demodulate received signals back to baseband.
Error correction systems: correct errors that occur in high-speed data transmission due to noise and interference.

At least one signal processing unit configured to convert the first electrical digital output signal to a binary signal may be further comprised in the digital optical computing processing unit. The at least one signal processing unit may comprise electrical/electronic circuits able to convert a digital signal into a binary signal. The digital signal may be a multi-level digital signal, therefore a processing unit may be needed to convert the multi-level digital signal into a binary digital signal. A binary digital signal is easier to handle by common electronic processing units such as field-programmable gate array (FPGA). The at least one signal processing unit may comprise electronic signal processing circuits that can be suitable for decoding a multi-level electrical digital signal to a binary signal.

In one embodiment, an output of the first electrical-to-optical transducer is connected to an input of the second electrical-to-optical transducer. The first and the second electrical-to-optical transducers may have an input and an output, wherein the input and the output are connected to each other. The input and the output may be connected by a waveguide or may directly be connected. In embodiments, the electrical-to-optical transducer is symmetric, such as the input can be the output and vice versa. In an embodiment, “arranged in series” may mean that the output of the first electrical-to-optical transducer is connected to the input of the second electrical-to-optical transducer.

In the present disclosure, “arranged in series” may be understood with its broadest meaning. “arranged in series” can be understood as a configuration where components or items are connected end-to-end in a single line or sequence. By sequence, this would be understood as a chain-like structure, where components or items would be connected on the same chain, but not necessarily directly connected to each other. As an example, the first electrical-to-optical transducer can be arranged in series with the primary electrical-to-optical transducer, while not necessarily being connected to each other, but sharing the same optical signal, i.e. the first optical signal on the first waveguide.

The at least first and second electrical-to-optical transducer can be arranged in parallel. The first waveguide comprising at least two wavelengths could be split into at least two secondary waveguides, where each of the secondary waveguides comprise one wavelength of the at least two wavelengths. The at least first and second electrical-to-optical transducer can be wavelength-independent electrical-to-optical transducer since the at least first and second electrical-to-optical transducer would be respectively arranged on one of the secondary waveguides. The secondary waveguides could then be recombined into a first output waveguide by combining the at least two wavelengths in the first output waveguide. In embodiments, the recombination of the at least two wavelengths could be processed by an arrayed waveguide grating, or by a photonic wavelength demultiplexer. In embodiments, the split of the at least two wavelengths can be processed by an arrayed waveguide grating, or by a photonic wavelength demultiplexer.

In another embodiment, the primary electrical-to-optical transducer is wavelength-independent. The primary electrical-to-optical transducer may be configured to modulate all the wavelengths comprised in an optical signal passing through it with the same information/data. The optical signal may comprise at least two wavelengths, such as two, ten, fifty or more wavelengths. In embodiments, the primary electrical-to-optical transducer may be a Mach-Zehnder modulator (MZM) or an electro-absorption modulator (EAM). A MZM is an interferometric structure made from a material with strong electro-optic effect (such as LiNbO3, GaAs, InP). Applying electric fields to the arms changes optical path lengths of the optical signal passing through it resulting in phase modulation. Combining two arms with different phase modulation converts phase modulation into intensity modulation. This intensity modulation may be wavelength-independent. An EAM may typically consist of a semiconductor waveguide that is doped with a material that exhibits the electro-absorption effect, such as Indium Gallium Arsenide/Indium Phosphide (InGaAs/InP) or Gallium Arsenide/Aluminum Gallium Arsenide (GaAs/AlGaAs). In an EAM, an optical signal is passed through the waveguide, and an electrical bias voltage is applied across the waveguide to modulate the absorption of the material. This causes the refractive index of the material to change in response to the applied voltage, which in turn modulates the intensity of the optical signal passing through the waveguide. In embodiments, the intensity modulation may be wavelength-independent. MZMs may be well-suited for high-speed modulation and low power consumption applications, while EAMs can be ideal for low-voltage modulation and simple biasing and temperature control.

The at least first and second electrical-to-optical transducers can be wavelength-dependent. The at least first and second electrical-to-optical transducer may be configured to modulate a specific group of wavelengths comprised in an optical signal passing through each of them. In embodiments, the specific group of wavelengths of each of the at least first and second electrical-to-optical transducer may not overlap. This would allow the digital optical computing processing units to specifically modulate certain group of wavelengths with different electrical digital signals, such as the at least first, second and/or third electrical digital signals as described herein. The at least first and second electrical-to-optical transducers may be configured to modulate a range of wavelengths. The range of wavelengths may be defined as a plurality of wavelengths being close to each other.

The range of wavelengths can be defined as a band of the wavelength spectrum, such as the wavelength spectrum used in optical waveguide as defined in this application. In embodiments, the wavelengths may be comprised between 1.3 to 1.6 μm, or between 1.1 to 1.7 μm.

In embodiments, the at least first and second electrical-to-optical transducers may be configured to have a passband or an E/O bandwidth comprised between 30 and 50 GHz, between 35 and 45 GHz, between 37 and 43 GHz, or between 39 and 41 GHz. The term “passband” can be described as relative to an optical carrier, therefore the term “passband” is used in this patent application. The term “E/O bandwidth” may be described as an inherent bandwidth of the at least first and second electrical-to-optical transducers, which would measure how quickly the at least first and second electrical-to-optical transducers can respond to changes in an electrical input and produce corresponding optical output. The passband of the at least first and second electrical-to-optical transducers may be defined in regards to frequency or wavelength. The wavelength is inversely proportional to the frequency of a wave. Therefore, the passband in wavelength of the at least first and second electrical-to-optical transducers can be calculated with the following equation:

$$λ = \frac{c}{n ( {λ}_{0} ) \cdot f} \qquad ( 1 )$$

where c is the speed of light in vacuum, n(λ₀) is the refractive index of the medium at wavelength λ₀ and f is the frequency of the wave. The range of wavelengths as defined herein may refer to the passband bandwidth as defined therein. The refractive index of the silicon may be around 3.4 to 3.8. The micro-ring resonators may be configured to slightly change the refractive index of the medium, such that a better selectivity of the wavelengths can be achieved.

The at least first and second electrical-to-optical transducers may be at least a first and a second micro-ring resonator or at least a first and a second cascaded Mach-Zehnder.

The cascaded Mach-Zehnder can be designed to act as a wavelength filter, by taking the benefit of the wavelength-dependent phase shift that occurs in the device. When light of different wavelengths passes through a material or optical component, it can experience a different phase shift depending on the wavelength. By choosing the length and refractive index of the waveguides in each MZI stage, it may be possible to create a wavelength-dependent phase shift that can cause the device to transmit or reflect specific wavelengths of light. For example, a cascaded Mach-Zehnder can be designed as a bandpass filter, where only a certain range of wavelengths is transmitted while other wavelengths are reflected or attenuated. This is achieved by selecting the lengths and refractive indices of the waveguides in each stage such that the phase shift accumulates to a maximum value for the desired wavelengths, while canceling out for other wavelengths. Alternatively, a cascaded MZI can be designed as a notch filter, which transmits most wavelengths but blocks a specific narrow range of wavelengths. This is achieved by adding a phase shift that is out of phase with the desired wavelength, resulting in destructive interference that cancels out the transmission of that wavelength.

The micro-ring resonator is a passive device that consists of a waveguide loop that is coupled to a waveguide, such as the first waveguide as disclosed herein. The micro-ring resonator uses the principle of resonant wavelength filtering to selectively enhance or suppress specific wavelengths of an optical signal. When light is coupled into the first waveguide, a portion of the light is coupled into the micro-ring, where it circulates around the ring. The resonance condition of the micro-ring determines which wavelengths are transmitted or reflected from the device.

By applying an electrical signal to the micro-ring resonator, the resonance condition of the device can be changed, which allows for the selective modulation of specific wavelengths of light. This makes micro-ring resonators useful in wavelength-selective switching, filtering, and modulation applications. Micro-ring resonators can also be used to modulate a group of wavelengths rather than a single wavelength.

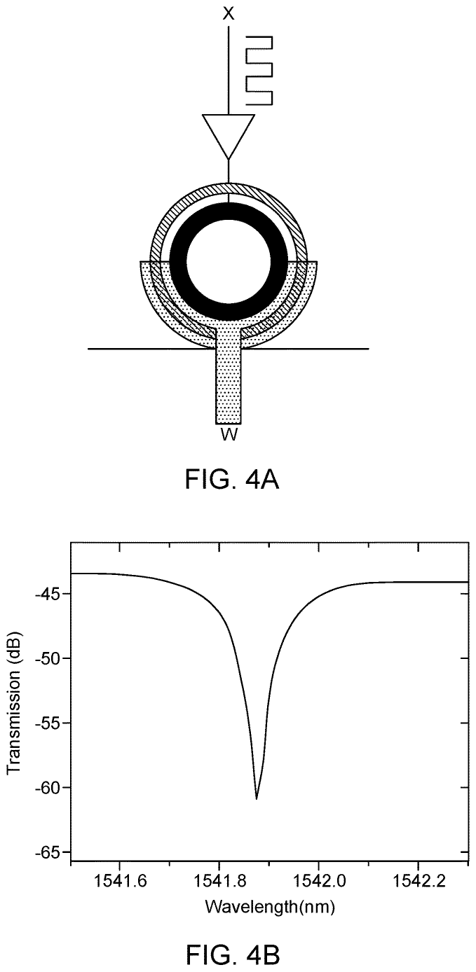

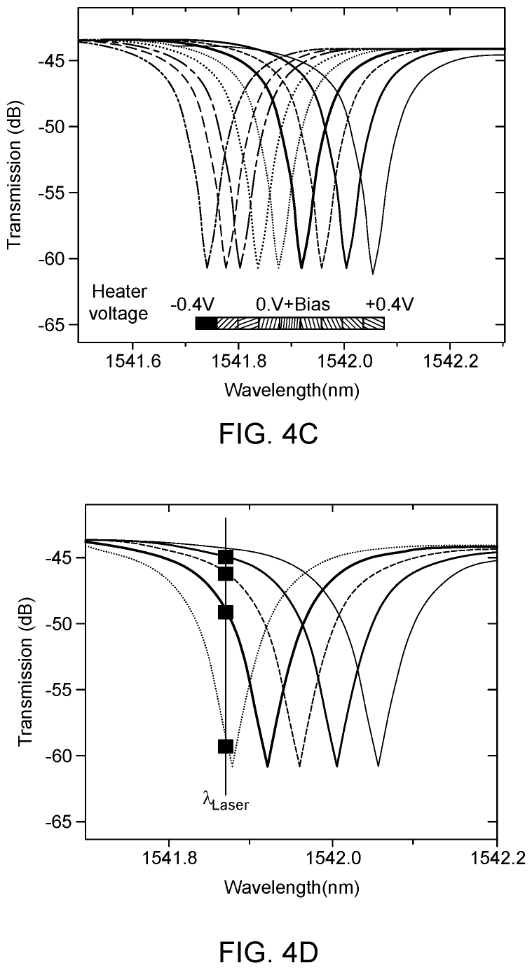

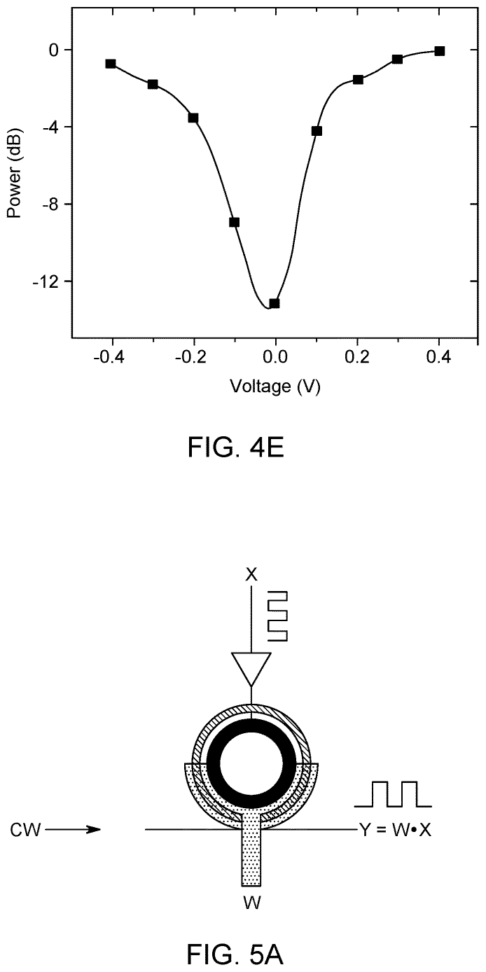

The at least first and second micro-ring resonators comprise at least a first and a second heater modulator. In the case of a micro-ring, a heater modulator can be comprised in the micro-ring to adjust the selectivity of the wavelength. A heater modulator can be a metal heater layer placed on top of a waveguide with a dielectric layer in between. The heater modulator may be limited by the so-called RC effect. The RC effect may therefore limit the modulation of the heater modulator to kHz-range modulation rates. The heater modulator may be used to heat the metal layer, thereby affecting the refractive index n of a material. This phenomenon is called the thermo-optical effect. As the temperature increases, the refractive index of the silicon increases, which may be the material used for the waveguide as disclosed herein, such as the first waveguide. The refractive index may switch the resonance condition of the heater, thereby switching the wavelength selectivity. This may allow some wavelengths to pass through the micro-ring resonator and some others to be blocked. FIG. 4A shows a schematic view of an embodiment of a micro-ring resonator. The micro-ring resonator comprises a heater modulator and a radio-frequency modulator. The radio-frequency modulator may be based on the plasma diffusion effect of a PN junction being comprised in the micro-ring resonator. By applying a high-speed varying electric field to a doped silicon waveguide, high-speed modulation of the carriers can be achieved, thus changing the refractive coefficient of the material at high-speed rates and finally obtaining a high-speed modulated optical signal based on a high-speed electrical signal. The PN junction of the micro-ring resonator may be processed such as the capacitance between the p and the n junction is minimal, such as the bandwidth of the radio-frequency modulator can be maximized.

The heater modulators of the at least first and second electrical-to-optical transducers may be configured to be controlled by the at least first and second weights. Weight may be named according to neural networks terminology, where a weight refers to a set of parameters that may be learned during a training process to adjust the behaviour of the network. A neural network may be made up of multiple layers of interconnected nodes, or neurons, which process and transmit information. In between the input and output layers, there may be one or more hidden layers that perform complex computations on the input data. Each neuron in a layer receives input from the neurons in the previous layer, applies a mathematical function to that input, and produces an output signal that is passed on to the next layer. The weights in a neural network represent the strength of the connections between neurons. Each neuron in a layer is connected to every neuron in the next layer, and each connection has an associated weight. During the training process, the network adjusts these weights to improve its performance on a particular task, such as image recognition or language translation.

The weights are initialized with random values at the beginning of the training process, and then updated iteratively using an optimization algorithm such as gradient descent. The goal of the optimization algorithm is to minimize a loss function, which measures the difference between the network's predictions and the true values. By adjusting the weights, the network can learn to make more accurate predictions on the training data, and generalize to new, unseen data. FIGS. 4B-C show graphs illustrating a micro-ring resonator transmission curves with different biases. FIG. 4D shows transmission loss at a given wavelength and FIG. 4E shows residual power after the micro-ring resonator at the given wavelength for different bias voltages. FIG. 4B shows an example of a transmission curve for a micro-ring resonator having a given length of the ring, FIG. 4C shows the effect of different bias voltages on the micro-ring resonator. The different bias voltages shift the resonance of the micro-ring in regards to the wavelength. The resonance is defined as the area of the transmission curve where a minimum intensity of the optical power transmission is achieved. As it is shown in FIG. 4D, it may be desirable to set the bias voltage of the micro-ring resonator such that the wavelength on which the micro-ring may modulate the first optical signal has a maximum and a minimum intensity. FIG. 4E shows the residual power at the output of a micro-ring resonator on a given wavelength when the bias voltage of the heater modulator is switched between −0.4 and 0.4 V.

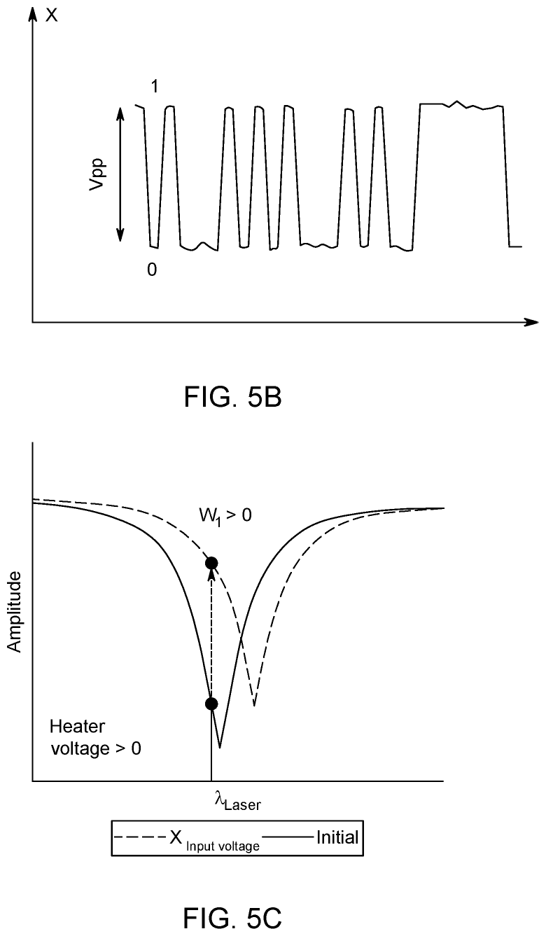

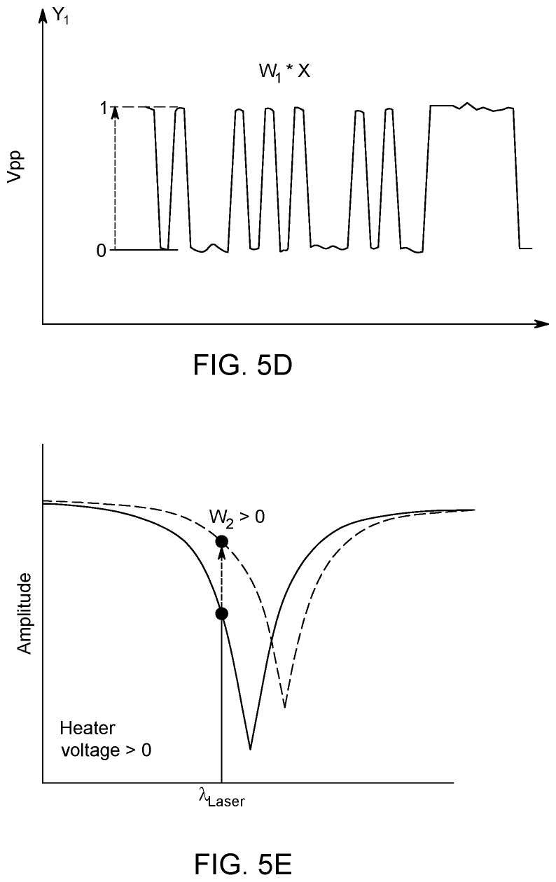

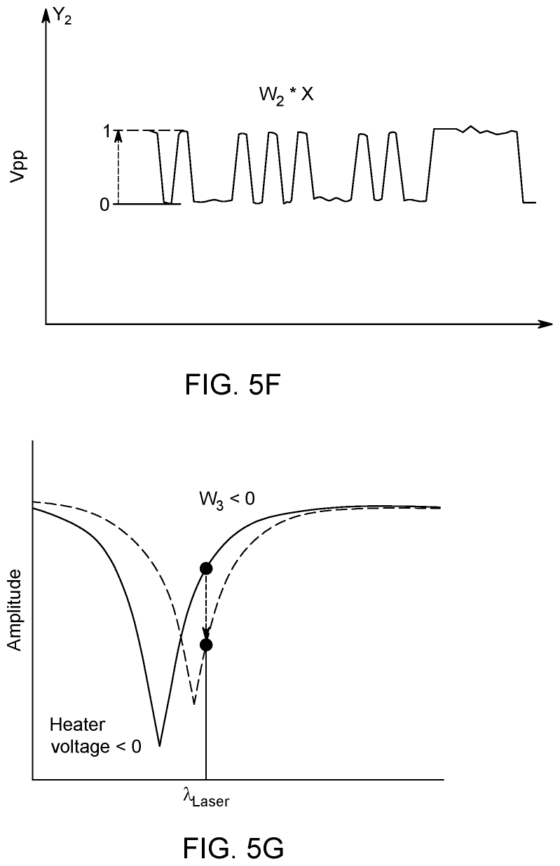

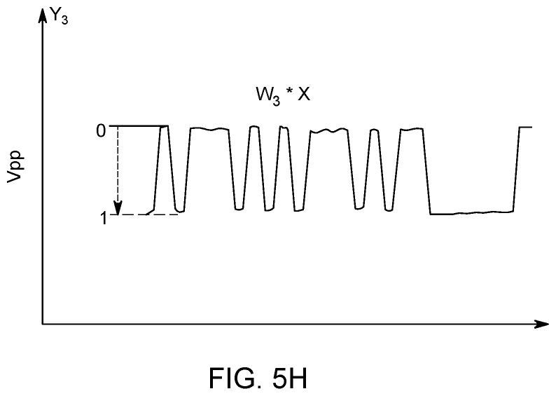

In an embodiment, the at least first and second weights are normalized and are comprised between −1 and +1. FIG. 5A shows a schematic view of an embodiment of a micro-ring resonator. In embodiments, the heater modulator is controlled or biased by a command signal named W, where this command signal may be an analogue signal. W may mean “weight” and this is the “weight” as described in the present disclosure. X is the high-speed signal used to modulate the optical signal passing through the micro-ring resonator. The optical signal is the CW signal, where the optical signal is a constant optical signal with a fixed amplitude at the input, and the optical signal is thereby modulated by the high-speed signal X at the output, and moreover biased by the weight W. Therefore the optical signal at the output of the micro ring resonator is called Y, where Y=W·X. FIG. 5B shows the signal X in a graph representing the amplitude of X in time, where the peak-peak amplitude of X is Vpp. 0 and 1 are the logical binary state of the signal X. FIG. 5C and FIG. 5D shows an example when W has a first positive value. The resulting modulated optical signal has a Vpp which is comprised between the two dots of FIG. 5C. The upper dot is on the transmission curve of the micro-ring resonator when the high-speed signal X becomes more positive than during the initial state. FIG. 5E and FIG. 5F shows an example when W has a second positive value. The resulting modulated optical signal has a Vpp which is comprised between the two dots of FIG. 5E. As it can be seen, this second positive value of W gives a modulated optical signal with a lower peak-peak amplitude than the modulated optical signal of FIG. 5D. FIG. 5G and FIG. 5H shows an example when W has a negative value. As it is shown on FIG. 5H, the polarity of the modulated optical signal is then flipped, with an amplitude corresponding on the distance between the two dots seen on FIG. 5G. By adjusting the voltage applied on the heater modulator, a control of the amplitude of the modulated optical signal can be performed. As a person skilled in the art would understand, the command signal W, defined as weight, as a maximum and a minimum. This maximum can be normalized as +1 and this minimum can be normalized at −1. Therefore, the at least first and second weights as described herein can be normalized and comprised between −1 and +1.

The at least first and second weights may be represented by at least a first and a second electrical digital weight signal. The first and second electrical digital weight signal may carry the value of the weight in the digital weight. The information may be digitally coded with multi-level signals or binary signals, and can be implemented in the system in a weight processing unit that may be configured to decode the at least first and second electrical digital weight signal into at least a first and second signal that would be suitable to control the heater modulators in a configuration wished by the user or the system. The digital optical computing processing unit may further comprise a digital-to-analogue converter (DAC) configured to convert the at least first and second electrical digital weight signals into at least a first and a second electrical analogue weight signals. By converting the at least first and second digital weight signals into at least first and second electrical analogue weight signals, a control of the heater modulators can be achieved. Heater modulators may be controlled by analogue signals, since heater modulators are configured to heat a metal layer. Therefore, analogue signals may be more suitable than digital signals.

In one embodiment, the at least first and second electrical analogue weight signals are at least a first and a second bias signal. In embodiments, the at least first and second bias signal can be configured to provide at least a first and a second bias to the heater modulators in order to fine tune the bandwidth of the micro-ring resonators and to define an operating point of the micro-ring resonators. The operating point may define a peak-to-peak value of the optical signal being modulated by an electrical digital signal or an electrical analogue signal in the micro-ring resonator. The at least first and second bias signals can be configured to bias the at least first and second heater modulators of the at least first and second electrical-to-optical transducers, respectively. The at least first and second heater modulators are configured to modulate at least a first and a second amplitude of the first and the second wavelengths, respectively, of the first optical signal.

The at least first and second weights may be weights of a weight matrix of a neural network. In the context of a neural network, a weight matrix may be a mathematical representation of the connections between the neurons in two adjacent layers of the network. It can be a rectangular array of numbers that may specify the strength and direction of the connections between each neuron in the current layer and each neuron in the next layer. For example, consider a neural network with an input layer of 10 neurons, a hidden layer of 5 neurons, and an output layer of 3 neurons. The weight matrix between the input layer and the hidden layer would be a 5×10 matrix, where each row can correspond to a neuron in the hidden layer and each column may correspond to a neuron in the input layer. Similarly, the weight matrix between the hidden layer and the output layer would be a 3×5 matrix. During training, the values in the weight matrix can be adjusted to optimize the network's performance on a particular task, such as image recognition. The values in the weight matrix can determine the output of each neuron in the next layer, based on the inputs from the previous layer. In a convolutional neural networks or recurrent neural networks, the weight matrices may have a more specialized structure that reflects the specific properties of the data being processed.

The at least first, second and third electrical digital signals can represent at least a first and a second pixel information of an image. In the context of image recognition and/or processing, the digital optical computing processing unit configured to perform analogue-digital convolutions may be used to perform convolution between digital data representing an image and a weight matrix representing a convolution matrix or a kernel. In image processing, a kernel, convolution matrix, or mask is a small matrix used for blurring, sharpening, embossing, edge detection, and/or more. This can be accomplished by doing a convolution between the kernel and an image. As described herein, the convolution between the kernel and an image can be achieved with the digital optical computing processing unit configured to perform analogue-digital convolutions. By using a digital optical computing processing unit, noise can be reduced, therefore achieving better results than their analogue counterparts.

The at least first, second and/or third electrical digital signal may comprise at least one symbol. The at least first, second and/or third electrical digital signals may be multi-level electrical digital signals or binary signals. Each of them may comprise at least one symbol, such as 4, 8 or 16 symbols. The at least first, second and/or third electrical digital signals can be binary signals. The at least first, second and third electrical digital signals can represent at least a first, second and third inputs, wherein each of the at least first, second and third inputs are encoded in a binary word. By encoding the at least first, second and third inputs within a binary word, a digital-to-analogue converter for the input is not needed and the resolution of the analogue-to-digital converter comprised in the signal post-processing unit can be greatly reduced. Analog optical matrix multiplication systems rely on analogue photonic multiplication cores, where the input and weight originates from M-bit and N-bit DACs in the electrical domain. If the order of the matrix is L, this generates an optical signal with L×(2^{M}−1)×(2^{N}−1) possible levels. The present disclosure discloses systems and methods where the inputs are electrical digital signals, in embodiments, encoded in a binary word. If the input is encoded in a binary word, this generates an optical signal with L×(2^{N}−1) possible levels. By having an input encoded in a binary word, wherein the input can be the at least first, second and third electrical digital signals, the requirements for the ADCs comprised in the signal post-processing unit can be released by M bits. By eliminating the need for a high-speed digital-to-analogue converter at the input, the digital optical processing unit reduces costs, saves energy and simplifies system complexity. In embodiments, the at least first, second and third electrical digital signals can represent an input encoded in a binary word, wherein the binary word may have a length of 8-bit, a length of M-bit, wherein M can be comprised between 2 and 256, between 8 and 128, between 8 and 1024, or between 2 and 2048. In the context of image processing and/or recognition, the at least first, second and/or third electrical digital signals can represent a pixel of an image. The number of distinct colors that can be represented by a pixel may depend on the number of bits per pixel (bpp). A 1 bpp image uses 1 bit for each pixel, so each pixel can be either on or off. Each additional bit doubles the number of colors available, so a 2 bpp image can have 4 colors, and a 3 bpp image can have 8 colors, while 8 bpp can have 256 colors, 16 bpp may have 65536 colors, also named as Highcolor, and 24 bpp can have 16777216 colors, also named as Truecolor. For color depths of 15 or more bits per pixel, the depth may be normally the sum of the bits allocated to each of the red, green, and blue components. Highcolor, usually meaning 16 bpp, normally has five bits for red and blue each, and six bits for green, as the human eye is more sensitive to errors in green than in the other two primary colors. For applications involving transparency, the 16 bits may be divided into five bits each of red, green, and blue, with one bit left for transparency. A 24-bit depth allows 8 bits per component. On some systems, 32-bit depth is available: this means that each 24-bit pixel has an extra 8 bits to describe its opacity, e.g. for purposes of combining with another image.

The at least one symbol is processed with a symbol data rate into the digital optical computing processing unit. The symbol data rate may be defined according to the bandwidth of the digital optical computing processing unit. In general, the bandwidth of a system may be limited by the features/devices included in the system. The electrical-to-optical transducers and/or the optical-to-electrical transducers may have an inherent bandwidth which would limit the symbol data rate that can be achieved through the system. Compared to digital multiplier implementations, the bandwidth may remain higher due to the use of silicon photonics, which may allow a higher symbol data rate for processing data. The at least one symbol comprised in the at least first, second and/or third electrical digital signals may be the input of the radio-frequency modulator of the micro-ring resonator. Therefore, the symbol data rate can be maximized, depending on the bandwidth of the radio-frequency modulator of the micro-ring modulator. In embodiments, the symbol data rate may be half of the bandwidth of the radio-frequency modulator of the micro-ring modulator, two third of the bandwidth of the radio-frequency modulator, or three quarter of the bandwidth of the radio-frequency modulator.

In one embodiment, the first waveguide portion is configured to introduce a wavelength-dependent time delay. A wavelength-dependent time delay is a time delay which is dependent on the wavelength of an optical signal. If an optical signal comprises more at least two wavelengths, then the first waveguide portion may introduce a time delay which is dependent on each one of the at least two wavelengths comprised in the optical signal. Thereby, one wavelength may be delayed by a different time delay than another wavelength, where both wavelengths are comprised in the optical signal.

In an embodiment, the first waveguide portion is a dispersive waveguide portion. A dispersive waveguide is designed to support the propagation of dispersive waves, which are waves that travel at different velocities depending on their wavelength or frequency. A dispersive waveguide may typically consist of a core region surrounded by a cladding region, both of which can be made of materials with different refractive indices. The core region may be designed to confine the optical field, while the cladding region can provide a boundary that keeps the light inside the waveguide. When an optical signal is introduced into the waveguide, it experiences a change in velocity as it travels through the dispersive medium. This change in velocity is due to the dispersive properties of the medium, which can cause the different frequency components of the signal to propagate at different velocities. As a result, the signal becomes distorted and spreads out in time and space as it travels through the waveguide. In a dispersive waveguide, the amount of dispersion can be controlled by adjusting the design of the waveguide, such as the dimensions of the core and cladding regions or the materials used. By carefully controlling the dispersion, it can be possible to achieve a variety of useful effects, such as pulse compression, time delay, or frequency filtering. The dispersive waveguide portion may be a photonic crystal or a chirped Bragg grating.

A chirped Bragg grating (CBG) is a type of optical device that can be used to manipulate the spectral properties of light. It is in essence a type of Bragg grating, which is a periodic structure that reflects certain wavelengths of light while allowing others to pass through, but with the added feature of a spatially varying period. A Bragg grating can be typically composed of alternating layers of high and low refractive index materials, such as silica and germanium. These layers may act as a periodic refractive index structure, which can create a wavelength-dependent reflection of light. In a conventional Bragg grating, the period of the structure can be constant throughout the length of the grating, and the reflected wavelength may be fixed. In contrast, a chirped Bragg grating has a varying period along its length, which may cause the reflected wavelength to shift as a function of position. The period of the grating can be typically increased or decreased linearly along the length of the grating, which results in a linear chirp of the reflected wavelength. This may allow a CBG to reflect a range of wavelengths rather than just a single wavelength.

The dispersive waveguide portion can be configured to generate a time delay between the at least two wavelengths. This time delay may be relative to a symbol data period, wherein the symbol data period is the inverse of the symbol data rate as described herein.

In embodiments, a person skilled in the art would implement any methods or systems that would be suitable to disperse the first optical signal in order to generate a time delay between the at least two wavelengths.

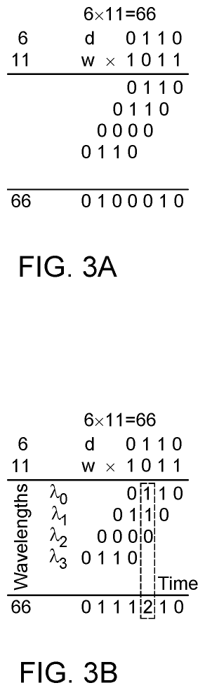

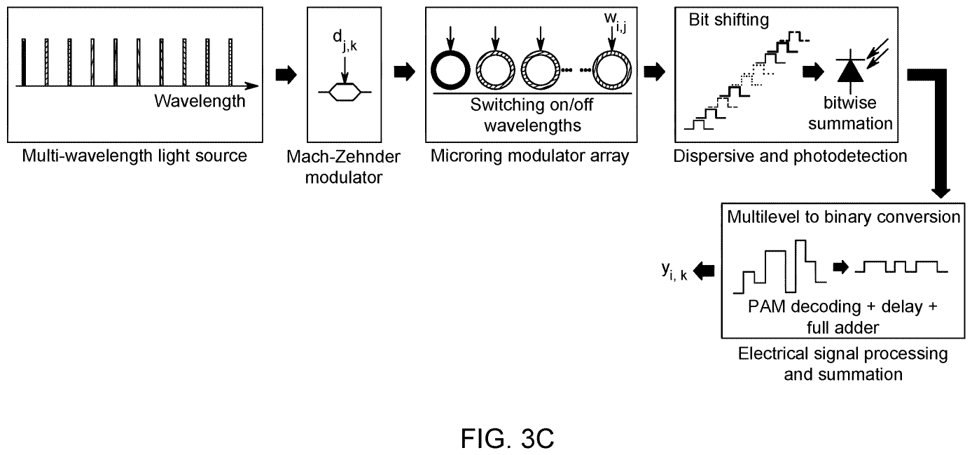

In embodiments, the time delay is 100% of the symbol data period, comprised between 100% and 110% of the symbol data period, comprised between 100% and 150% of the symbol data period, or comprised between 100% and 200% of the symbol data period. As shows in FIG. 3C, it may be desirable that the time delay may be closed to the symbol data period such as the summation of the different wavelengths in the photodetector can be performed at the same time, and at the same clock cycle.

The light source may be a laser source. The laser source may be configured to generate the first optical signal. The first optical signal may comprise at least two wavelengths. There may be several ways to generate an optical signal comprising at least two wavelengths:
Optical Frequency Comb: An optical frequency comb may be a tool that can produce a spectrum of equally spaced frequency components. This can be done using a mode-locked laser, which emits ultra-short pulses that are closely spaced in time. When these pulses are propagated through a dispersive element, such as a fiber or a grating, and wherein these components may be included in the light source, they spread out in time and form a series of equally spaced frequency components. By filtering and amplifying the desired frequency components, an optical signal comprising multiple wavelengths can be generated.
Supercontinuum Generation: Supercontinuum generation can be a process where an intense optical pulse is propagated through a nonlinear medium, such as a photonic crystal fiber. The pulse broadens due to self-phase modulation, which causes different frequency components to travel at different speeds and leads to a spectral broadening. This broadened spectrum can be used to generate an optical signal comprising multiple wavelengths.

The digital optical computing processing unit may further comprises a phase modulator. It may be possible to generate multiple wavelengths from a laser source by using a phase modulator. A phase modulator can be a device that can be used to modulate the phase of the optical signal generated by the laser source. There are few steps to be performed in order to generate an optical signal comprising at least two wavelengths from a laser source that includes a phase modulator. The laser source emits a single wavelength of light, the phase modulator is inserted into the path of the laser beam, the modulator changes the phase of the laser light in a controlled way and the modulated laser beam is directed to a frequency mixer that combines the modulated signal with the original signal to generate new frequencies. The output of the frequency mixer is a beam of light that contains multiple wavelengths. The process of generating multiple wavelengths with a laser source and a phase modulator is called frequency comb generation.

The laser source and the phase modulator may generate a frequency comb. A frequency comb may contain a series of equally spaced spectral lines, or “teeth”, that are evenly spaced in frequency. Each tooth in the comb corresponds to a specific frequency or wavelength of light. The spacing between the teeth is very precise and is typically on the order of tens of gigahertz.

The at least two wavelengths are separated from one another by a frequency spacing. The frequency may be equal between each of the at least two wavelengths or can be different, such as two wavelengths can be separated by a first frequency spacing and two other wavelengths comprised in the same optical signal can be separated by a second frequency spacing, where the first and the second frequency spacing are different. The first frequency spacing can be equal to the second frequency spacing. In this specific case, the frequency spacing may be defined as a comb frequency spacing.

The at least first, second and third electrical digital signal may be multi-level digital signals and/or binary signals.

In an embodiment, the digital optical computing processing unit further comprises a carrier wave generator. The carrier wave generator may be configured to generate at least one carrier wave. Each one of the at least one carrier wave have an oscillating frequency. The oscillating frequency can be comprised between 1 Hz to a maximum allowable oscillating frequency which may be defined by the following equation:

$$Fosc = {BW}_{O E} - \frac{B {W}_{sig}}{2} \qquad ( 2 )$$

where BWOE is the bandwidth of the optical-to-electrical transducer used in the digital optical computing processing unit, BWsig is the bandwidth of the electrical digital signals used to modulate the optical signal. The maximum oscillating frequency can be found according to the Eq. (2), where few parameters of the system can modify the value of the maximum oscillating frequency.

The carrier wave generator may be an electronic oscillator, such as a feedback oscillator or a negative-resistance oscillator. A feedback oscillator is an electronic oscillator that generates a sinusoidal waveform by feeding back a portion of the output signal to the input of the amplifier. The feedback loop is designed to provide a positive feedback, which means that the output signal is in phase with the input signal and reinforces it. The circuitry can be based on active components such as transistors or operational amplifiers, or on passive components such as inductors and capacitors. A common example of a feedback oscillator is the Colpitts oscillator.

A negative-resistance oscillator is an electronic oscillator that generates a sinusoidal waveform by using a negative-resistance device, such as a tunnel diode or a Gunn diode. The negative-resistance device is used to create a resonant circuit with a positive feedback loop, which causes the circuit to oscillate. The negative resistance cancels out the losses in the circuit and provides the energy needed to sustain oscillations. Negative-resistance oscillators are often used in microwave applications because they can generate very high frequencies. An example of a negative-resistance oscillator is the Gunn oscillator.

There are many other types of electronic oscillators that can potentially be used such as phase-shift oscillators, crystal oscillators, and LC-tank oscillators.

The digital optical computing processing unit may further comprise at least one digital-to-analogue converter, wherein the at least one digital-to-analogue converter can be configured to convert the at least first, second and third electrical digital signals into at least a first, a second and a third electrical analogue signals. The at least first, second and third electrical digital signals may need to be converted into analogue signals in order to be modulated by at least one carrier wave. Carrier waves may be usually high frequency waves with fixed frequency values and can be typically used in communications to up-convert baseband signals to a fixed frequency value due to the limitations of the communication frequency source. The baseband signal can be usually low frequency and has a variable frequency width, such as the at least first, second and third electrical digital signals. To transmit a baseband signal, it will be multiplied with a high frequency carrier to increase the signal frequency to pass through the bandwidth of the communication channel.

The at least first, second and third electrical analogue signals can be modulated by the at least one carrier wave, thereby generating at least a first, a second and a third carrier-modulated electrical signals. By modulating the at least first, second and third electrical analogue signals by at least one carrier wave, some of the electrical analogue signals can be modulated with a first carrier wave while the others can be modulated with a second carrier wave. This may allow the first optical signal to be modulated with the at least first, second and third electrical analogue signals in at least one carrier, therefore increasing the bandwidth of the first optical signal. By having for instance two carrier waves, the overall bandwidth of the system can be multiplied by two. In other terms, for the same bandwidth, the digital optical processing unit may process twice the amount of data.

The at least first, second and third carrier-modulated electrical signals are modulated in quadrature or orthogonal between each other. By modulating the at least first, second and third carrier-modulated electrical signals in quadrature or orthogonal between each other, the signal format is then increased from one-dimensional to two-dimensional format. Consequently, there may be more possible states to represent the signal, such as quadrature amplitude modulation (QAM).

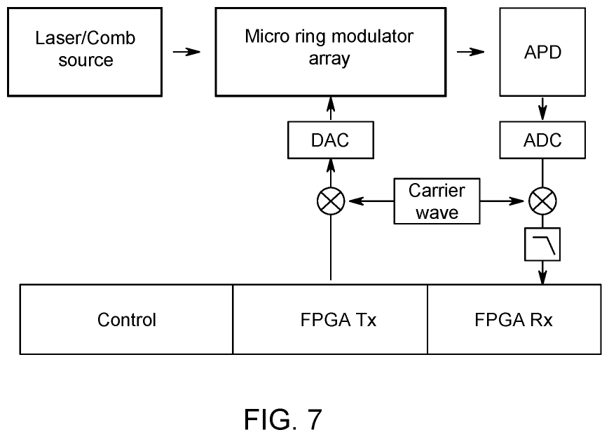

FIG. 7 shows a schematic view of an embodiment of the digital optical processing unit where the at least first, second and third electrical digital signals are modulated by a carrier wave. A FPGA is arranged on the transmitter side (Tx), and is outputting the at least first, second and third electrical digital signals into a mixer, where the mixer is configured to modulate the at least first, second and third electrical digital signals on a carrier wave. The at least first, second and third electrical digital signals are converted into at least a first, a second and a third electrical analogue signals by a DAC, and then injected into a micro-ring modulator array, where the micro-ring modulator array is configured to modulate an optical signal coming from the laser/comb source, with the at least first, second and third electrical analogue signals. An avalanche photodiode (APD) is configured to convert the optical signal modulated by the at least first, second and third electrical analogue signals into a first electrical output signal. This first electrical output signal is then converted into a first electrical digital output signal through an ADC, and a mixer in combination with a low-pass filter are configured to demodulate the carrier wave in order to retrieve a baseband signal. The baseband signal is then outputted to a FPGA on the receiver side (Rx), configured to further processed the baseband signal. In a digital optical computing processing unit as described in the present disclosure, the baseband signal may either contain a convolution result or a multiplication between two binary words.

The digital optical computing processing unit may further comprises an IQ modulation system. The IQ modulation system can be used to modulate the at least first, second and third electrical digital signals or the at least first, second and third carrier-modulated electrical signals in phase (I) and quadrature (Q) components. For instance, the at least first electrical digital signal can be modulated in phase while the at least second and third electrical digital signals can be modulated in quadrature. The IQ modulation system may be configured to modulate the at least first, second and third carrier-modulated electrical signals in quadrature or orthogonal between each other.

As a consequence, the first electrical output signal can be modulated according to a quadrature-amplitude modulation (QAM). In embodiments, the quadrature-amplitude modulation may be a quadrature-phase-shift-keying (QPSK) modulation, a 8-QAM, a 16-QAM, a 32-QAM, 64-QAM, a 128-QAM, a 256-QAM, a 512-QAM, or a 2N-QAM, where N is an integer.

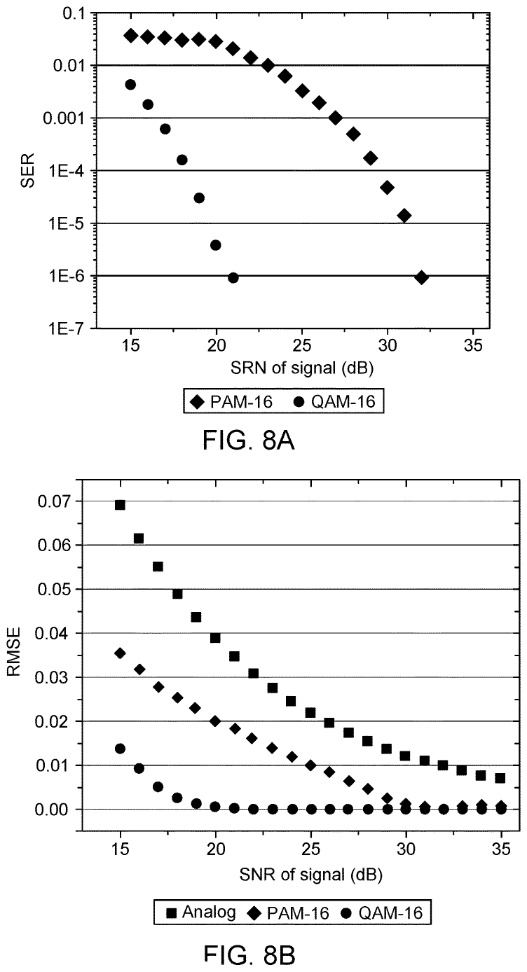

FIG. 8A shows a graph presenting a statistical summary of the correlation between signal to noise ratio (SNR) and signal error rate (SER) for a PAM-16 and a QAM-16 modulation scheme. The SER values for both the PAM-16 and QAM-16 signals drop precipitously when the signal-to-noise ratio (SNR) rises from 15 dB to 35 dB, while the QAM-16 signal falls at a steeper rate. When the SNR is greater than 22 dB, the SER value of the QAM-16 signal remains at 0. Meanwhile, the SER of the PAM-16 remains large. Unless the SNR exceeds 33 dB, the SER can be reduced to near zero. However, a system with a signal-to-noise ratio over 30 dB may be extremely difficult to achieve. This graph shows the benefit of a QAM modulation over a PAM modulation, where SER are better for any SNR.

FIG. 8B shows a graph presenting a statistical summary of the correlation between root-mean square error (RMSE) and SNR for an analogue scheme, PAM-16 and QAM-16 modulation scheme. The QAM-16 presents a benefit compared to the PAM-16 or the analogue scheme, where the RMSE is always lower for any values of the SNR. This is a clear benefit of the QAM modulation scheme over the PAM modulation scheme and the analogue scheme, and for the same numbers of level, i.e. 16 levels. The analogue scheme is the worst effective scheme. In embodiments, the present disclosure may only use electrical digital signals, therefore improving the SER and/or RMSE for any SNR of the digital optical processing unit as disclosed herein.

The first electrical output signal may be modulated by the at least one carrier wave. The first electrical output signal may be processed by the optical-to-electrical transducer, thereby generated based on the first optical signal. Since the first optical signal may be modulated by the at least first, second and third electrical digital signals that can be modulated on at least one carrier wave, the first electrical output may by modulated by the at least one carrier wave. The digital optical computing processing unit may introduce some impairments in the system which may slightly shift the at least one carrier wave frequency, but some processing can be performed in order to retrieve baseband information from the first optical signal.

The digital optical computing processing unit can further comprise an IQ demodulation system. The IQ demodulation system can be configured to demodulate the first electrical output signal into at least a first, a second and a third electrical digital output signals.

The at least one signal processing unit can comprise an analogue-to-digital converter (ADC) configured to convert the first electrical output signal into a first electrical digital output signal.

The at least one signal processing unit may further comprise digital signal processing filters and/or analogue or digital equalizers. In embodiments, these features may be comprised in the at least one signal processing unit since they can reconstruct the signal in order to better detect the information carried by the first electrical output signal. The first electrical output signal may have significant distortion and/or uneven distribution. The overall bandwidth of the digital optical processing unit may also be lower than required. In some cases, the symbol data period may be higher than the overall bandwidth needed to distinguish the information carried by the first electrical output signal. In embodiments, equalizers, analogue and/or digitals, may be configured to equalize the bandwidth, therefore equalizing the first electrical signal. By equalizing the first electrical signal, levels can be better distinguished, thereby facilitating the signal processing performed by the at least one signal processing unit.

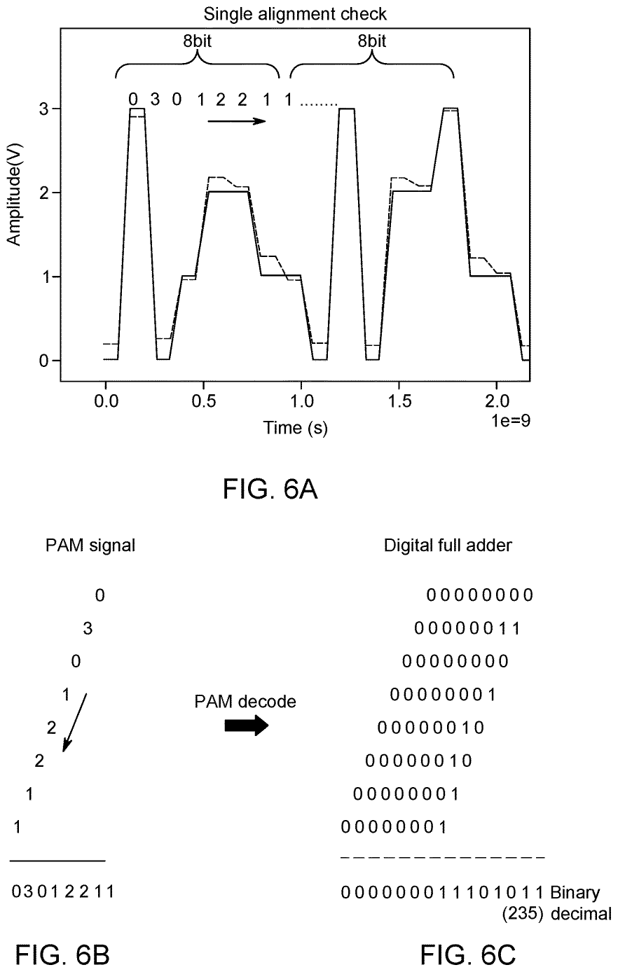

The at least one signal processing unit can further comprise an electrical signal processing unit, wherein the electrical signal processing unit comprises at least one multiplier and at least one full-adder. The at least one multiplier and the at least one full-adder can be used to generate a binary signal out of a multi-level electrical digital signal. FIG. 6A-C show an illustration of the different steps processed by the at least one signal processing unit. FIG. 6A shows the first electrical output signal. The first electrical output signal is a multi-level signal. In embodiments, the first electrical output signal is split by groups of 8 symbols in order to be processed. The first electrical output signal is then arranged in time with one clock period difference between successive symbols as shown in FIG. 6B. The first electrical output signal is then processed in a PAM decoder, which would convert the PAM signal into an 8-bit digital signal and maintains one clock period difference between successive symbols. All the 8 bits signals are then summed using a full adder, which is similar to an 8-bit multiplier, as shown in FIG. 6C. The PAM decoder may comprise and/or work with shift-add circuits, such as at least one multiplier and/or at least one full-adder as described herein. In embodiments, the PAM decoder can be an analogue-to-digital converter. The at least one signal processing unit can comprise an analogue-to-digital converter followed by at least one shift-and-add circuit. The at least one shift-and-add circuit may be at least one shift-add circuit. A person skilled in the art would understand that the at least one shift-add circuit is a common electronic circuit such as shift-and-add multipliers.

If a N×N 8-bit convolutional matrix multiplication is processed by a digital circuit logic, implemented with electrical circuit hardware possibilities, N multipliers and N−1 full adders would be needed. But with the digital optical processing units as disclosed herein, it may only require one multiplier in digital logic, implemented with electrical circuit hardware. This would save hardware and thereby power consumption.

Optical neural networks can be used in many fields. For example, autonomous driving. Many studies predict that autopilot vehicles will mature within 10 years. Using images to accurately identify cars and people in real-time for traffic monitoring is one of the greatest challenges. Recently, several deep learning approaches based on convolutional neural networks (CNNs) have been proposed for real-time recognition and classification in computer vision. The two most representative CNN models are

Faster R-CNN and YOLOv3 and several subsequent derivative versions. The size of convolutional kernels needed is 1×1 or 3×3. In those cases, the weight values are required with high precision, from 16 to 32 bits. It may be a challenge for the digital optical computing processing unit to process so many possible weight values while keeping a reasonable number of level in the multi-level signal that can be distinguished from each other.

In embodiments, the digital optical computing processing unit can further comprise a look-up table (LUT). The LUT method is widely used in optical communications, where it is used to map detected values to real data values. It may be a relatively simpler and may save energy consumption. A LUT may be implemented in a field-programmable gate array (FPGA). By implementing the LUT in a FPGA, this makes the LUT flexible in a way such that detected values can be mapped to different real data values in the table of the LUT. If logic circuit would be used as a LUT, the output of the logic circuit mapping the detected values to the real data values would be fixed by the architecture and the connection(s) of the logic circuit. The FPGA may offer a flexibility to the LUT that the logic circuit may not provide.

In an embodiment, the LUT is configured to store the at least first and second weights. In embodiments, the LUT can be configured to store a digital representation of the at least first and second weights.

In one embodiment, the LUT is configured to match the at least first and second weights with at least a first and a second normalized weight value.

In embodiments, the at least first and second normalized weight value may be arranged such that there are equally separated between each other, on a specific weight range. As a consequence, the multi-level signal obtained from the convolution may have equally spaced levels. This would desirably ease the detection of the levels of the multi-level signal, while enabling the LUT to match the at least first and second weights with the at least first and second normalized weight value. The LUT may allow a greater resolution of possible weight values, while the multi-level signal may be kept with equally spaced levels.

In embodiments, the at least first and second normalized weight values can be distributed in between −1 and 1, equally distributed in between −1 and 1, or equally distributed in between 0 and 1. If the normalized weight values are equally distributed in between 0 and 1, the electrical output signal may be a PAM-signal, with an equal space in between the levels of the PAM signal, thereby making it following the standards of PAM signals, which may ease the further processing of the electrical output signal in the processing unit.

In embodiments, multiple convolutional kernels can be mapped with the LUT. From the first electrical output, multiple convolutional kernel weight values can be mapped, thereby making it possible to convolve the at least first and second digital signals with a plurality of convolutional kernel weight values stored in a memory and then mapped with the LUT.

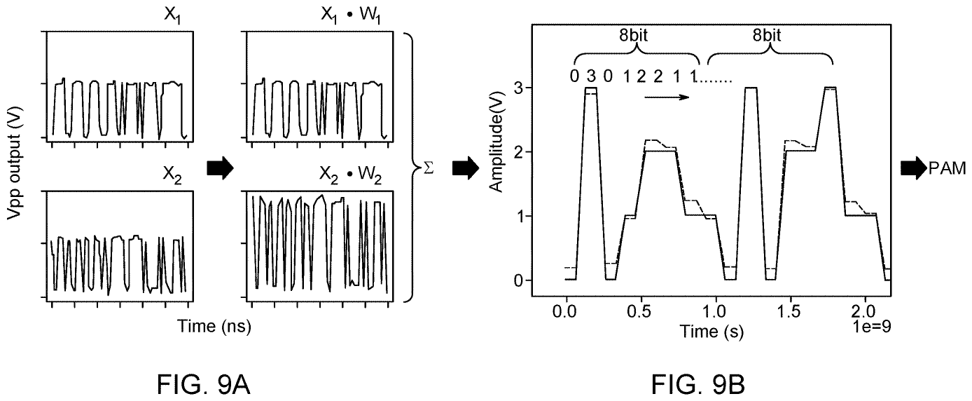

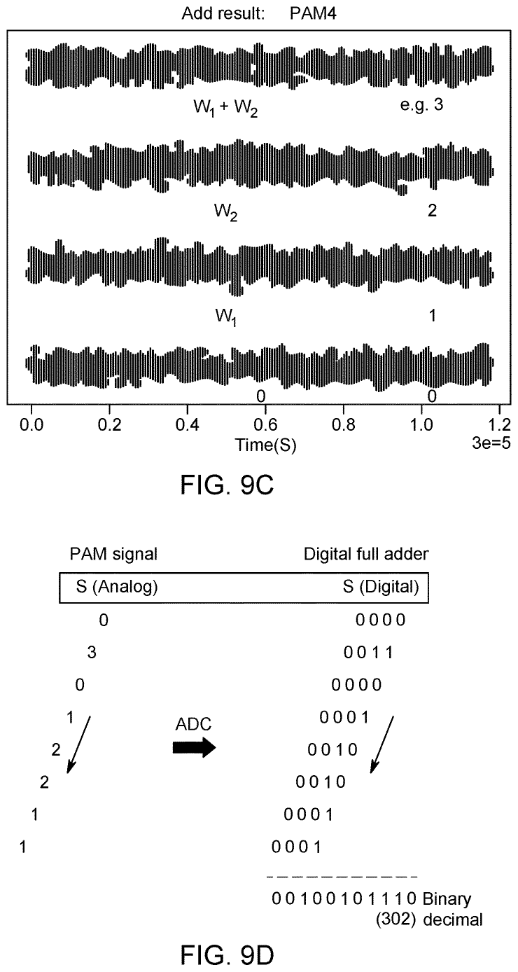

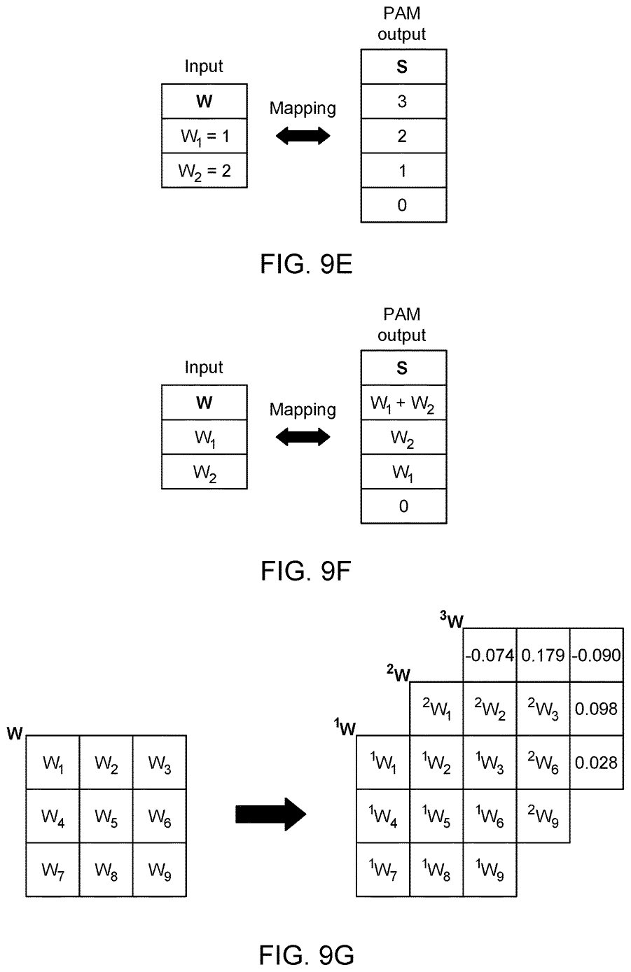

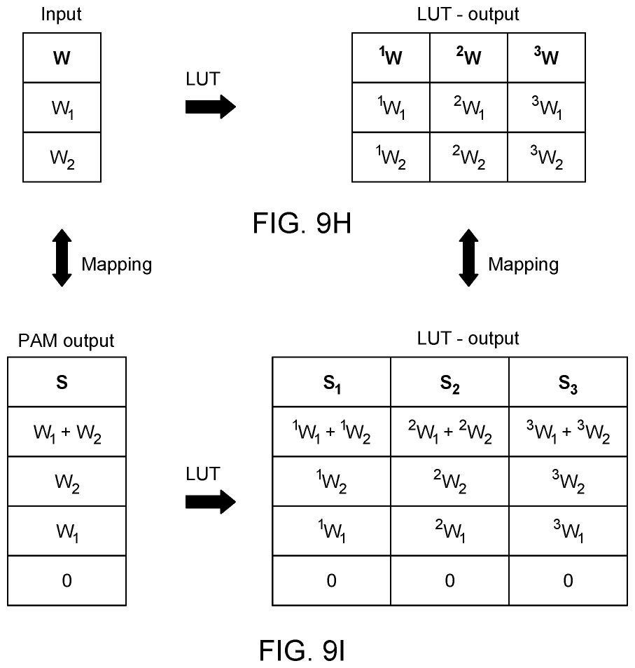

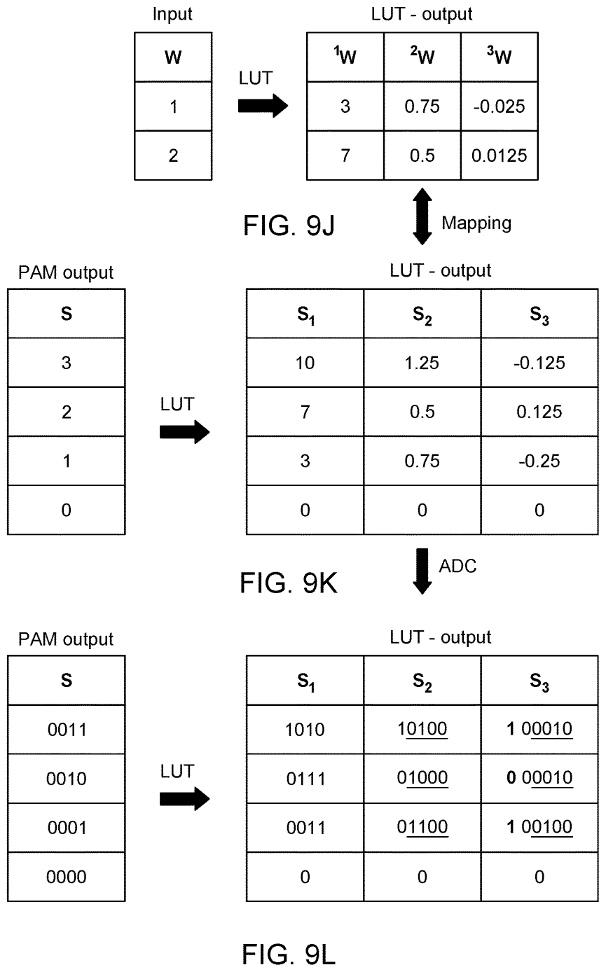

FIGS. 9A-L show an example of the LUT working principle as may be used in the disclosed digital optical processing unit. As shown in FIG. 9A, one optical signal is modulated on two wavelengths, where each of the two wavelengths is respectively modulated with a first electrical digital signal, x₁ and a second electrical digital signal, x₂, and where x₁ and x₂ modulates the optical signal in two micro-ring resonators having respectively a weight w₁ and a weight w₂. The amplitude of x₁ is assumed to be the same as the amplitude of x₂. Therefore, the first and the second electrical digital signal have the same peak to peak amplitude. These two modulated optical signals are then summed up to generate a PAM-4 signal, as shown in FIG. 9B. If w₁=1 and w₂=2, then the levels of the PAM-4 signal are equally spaced in voltage level distribution, which may ease the detection and further signal processing as described in the present disclosure. The PAM-4 signal can then be processed in order to be converted to a binary signal. FIG. 9C illustrates the mapping relationship that can exist between the weight value and the PAM-4 signal, as further described in FIGS. 9E-F. If the different levels of the PAM-4 signal are detected, the corresponding weight value can be mapped with the corresponding levels. FIG. 9G shows a convolution kernel matrix of a size 3×3. In many applications, multiple kernels need to be processed on the same input data. Therefore FIG. 9G also illustrates ¹W, ²W and ³W which are multiple convolutional kernels to be used on the same input data. Since the normalized weight values can be mapped with the LUT for a PAM-4 signal representing the first electrical output, a plurality of weight values can be mapped with the LUT for a PAM-4 signal representing the first electrical output as illustrated in FIGS. 9H-I. FIGS. 9J-L shows an example of the mapping of multiple convolutional kernels with one PAM-4 signal representing the first electrical output. A single input address in the LUT can correspond to multiple outputs, where the multiple outputs are the weights. The number of weights mapped from a single LUT input can be large, depending on the size of the memory which may be comprised in the digital optical processing unit. In embodiments, the output data can be of any length, i.e. 4-bit, 8-bit, 16-bit, 32-bit or 64-bit digital word lengths.

With this LUT method, the electrical part may need to handle the LUT and summation operations, and not the multiplication operations in the matrix multiplication, which may consume the most time and energy in the electrical matrix multiplication. In embodiments, all the kernel calculations in a layer can be obtained by only processing one first optical signal modulated by at least a first and a second electrical digital signals. The weight matrix can be easily adapted by updating the weight data stored in the LUT. This may desirably be well suited for training processes of a neural network, where weight values may change frequently.

Compared with electrical digital computing solutions, such as Google TPU, the digital optical processing unit comprising the LUT may only require at least one LUT and adders, but may not require multipliers, which can exceed adders in both transistor size and power consumption. For instance, an 8-bit adder requires 448 CMOS gates, while an 8-bit multiplier requires 3303 CMOS gates, which is 8 times more than a single adder.

The digital optical computing processing unit configured to perform analogue-digital convolutions can further process at least a fourth and a fifth electrical digital signals, and the digital optical computing processing unit configured to perform analogue-digital convolutions may further comprise: a second waveguide; a second light source, configured to deliver a second optical signal comprising at least two wavelengths to the second waveguide; at least a third and a fourth electrical-to-optical transducer arranged in series and comprised in the second waveguide, configured to be biased by at least a third and a fourth weight, wherein the at least fourth and fifth electrical digital signals modulate the second optical signal in the at least third and fourth electrical-to-optical transducers, respectively, and wherein the third electrical-to-optical transducer is configured to modulate a third wavelength and the fourth electrical-to-optical transducer is configured to modulate a fourth wavelength; a second optical-to-electrical transducer arranged at a second output of the second waveguide, and wherein the second optical-to-electrical transducer is configured to output a second electrical output signal based on the second optical signal.

A person skilled in the art would understand that the features described in the previous paragraph are similar to the features previously described in the present disclosure. By having these extra features, the digital optical computing processing unit configured to perform analogue-digital convolutions can further process at least a fourth and a fifth electrical digital signals. The digital optical computing processing unit configured to perform analogue-digital convolutions can then perform convolutions on two parallel and distinct paths, therefore increasing the speed by a factor of two. The same would apply by having an additional set of similar features, which would increase the processing/computing speed of the digital optical computing processing unit by a factor proportional to the similar features added to the system.

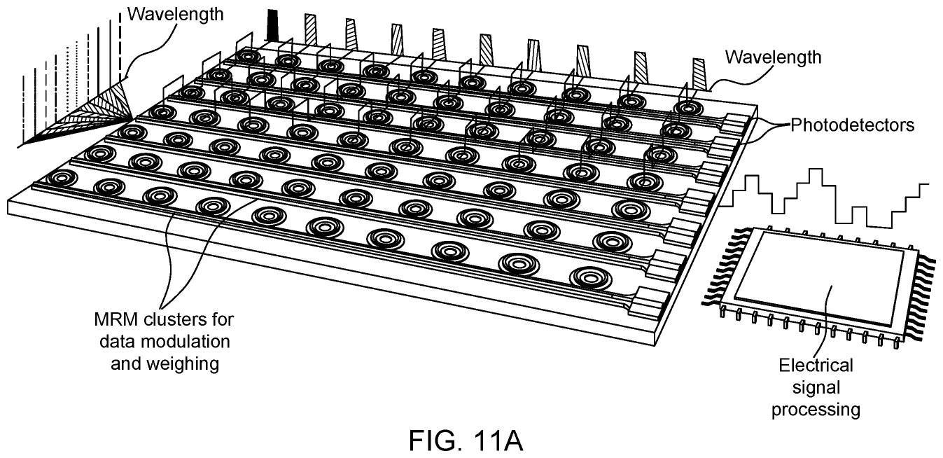

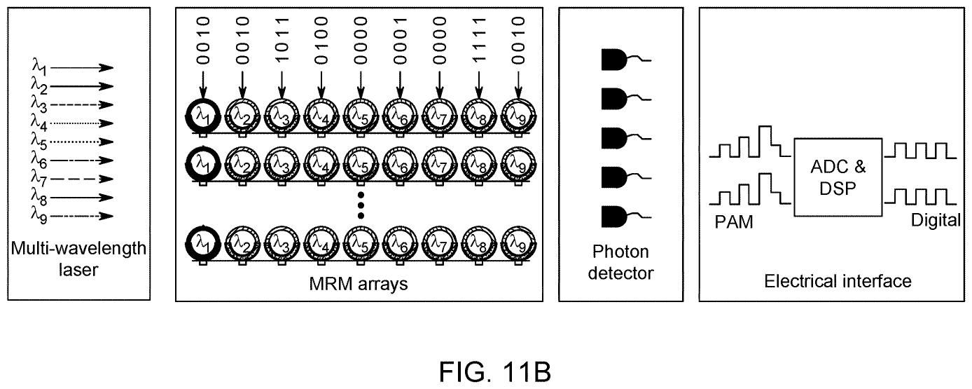

FIGS. 11A-B show a drawing and a schematic view of an embodiment of a digital optical processing unit with parallel waveguides. FIG. 11A shows a 3D view of an embodiment of a digital optical processing unit where multiple waveguides are comprised in the digital optical processing unit, therefore parallelizing the operations of convolution and/or multiplication as described in the present disclosure. FIG. 11B shows a schematic view of an embodiment of a digital optical processing unit with parallel waveguides where main functions are divided into categories, namely multi-wavelength laser, micro-ring arrays, photon detectors and electrical interface. The multi-wavelength lasers are the light source as described in the present disclosure, the micro-ring arrays are the at least first, second, third and fourth electrical-to-optical transducers as described in the present disclosure, the photon detectors are the first and second optical-to-electrical transducer and the electrical interface are the at least one processing unit and the at least one signal processing unit as described in the present disclosure.

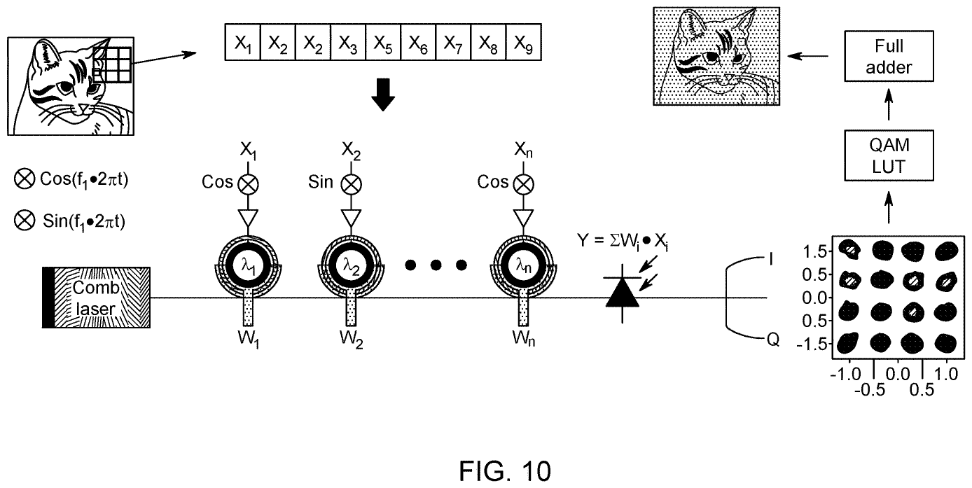

FIG. 10 shows a schematic view of an embodiment of the digital optical computing processing unit configured to perform analogue-digital continuous convolutions. A carrier wave oscillating at a frequency f₁ is comprised in the digital optical computing processing unit. An IQ modulation/demodulation system is also comprised in the digital optical computing processing unit, thereby allowing the electrical digital signals to be both modulated on the carrier wave and in quadrature with each other. The electrical digital signals are pixels of an image. For instance, X₁ and X₂ are modulated by the carrier wave and are in quadrature between each other, X₁ being modulated by cos(f₁*2πt) and X₂ being modulated by sin(f₁*2πt). The electrical digital signals X₁, X₂, . . . Xₙ, are multiplied by W₁, W₂, . . . Wₙ, respectively, where W₁, W₂, . . . Wₙ are normalized weights, as described in the present disclosure. These signals generated by the multiplication of the electrical digital signals and the weights are modulating the optical signal generated by the comb laser. The resulting multiplication between x₁ and W₁ modulates the optical signal on one wavelength, the resulting multiplication between x₂ and W₂ modulates the optical signal on a second wavelength and so forth. The optical signal is detected by a photodiode at the end of the waveguide. The photodiode converts the optical signal into an electrical output signal, which is then processed by a processing unit such as a FPGA and a QAM output is obtained. A LUT can match the obtained normalized weights to the actual weights, in order to generate a resulting digital data. Then the resulting digital data is processed by a processing unit in order to be converted into binary data, thereby generating the final result.

The digital optical computing processing unit configured to perform analogue-digital continuous convolutions can further process at least a fourth, a fifth and a sixth electrical digital signals, and the digital optical computing processing unit configured to perform analogue-digital continuous convolutions can further comprise: a second waveguide; a second light source, configured to deliver a second optical signal comprising at least two wavelengths to the second waveguide; a secondary electrical-to-optical transducer comprised in the second waveguide, wherein the second optical signal is modulated by the at least fourth electrical digital signal in the secondary electrical-to-optical transducer; at least a third and a fourth electrical-to-optical transducer arranged in series and comprised in the second waveguide, and further arranged in series with the secondary electrical-to-optical transducer, wherein the at least third and fourth electrical-to-optical transducers are configured to be biased or loaded by at least a third and a fourth weight, wherein the at least fifth and sixth electrical digital signals modulate the second optical signal in the at least third and fourth electrical-to-optical transducers, respectively, and wherein the third electrical-to-optical transducer is configured to modulate a third wavelength and the fourth electrical-to-optical transducer is configured to modulate a fourth wavelength; a second waveguide portion configured to disperse the second optical signal or to introduce a wavelength-dependent time delay in the second optical signal, wherein the second waveguide portion is comprised in the second waveguide and arranged before the at least third and fourth electrical-to-optical transducers; a second optical-to-electrical transducer arranged at a second output of the second waveguide, and wherein the second optical-to-electrical transducer is configured to output a second electrical output signal based on the second optical signal.

The digital optical computing processing unit configured to perform digital-digital multiplications can further process at least a fourth, a fifth and a sixth electrical digital signals, and the digital optical computing processing unit configured to perform digital-digital multiplications can further comprise: a second waveguide; a second light source configured to deliver a second optical signal comprising at least two wavelengths to the second waveguide; a secondary electrical-to-optical transducer comprised in the second waveguide, wherein the second optical signal is modulated by the at least fourth electrical digital signal in the secondary electrical-to-optical transducer; at least a third and a fourth electrical-to-optical transducer arranged in series and comprised in the second waveguide, and further arranged in series with the secondary electrical-to-optical transducer, wherein the at least third and fourth electrical-to-optical transducers can be configured to be biased or loaded by at least a third and a fourth weight, wherein the at least third and fourth electrical digital signals modulate the second optical signal in the at least third and fourth electrical-to-optical transducers, respectively, and wherein the third electrical-to-optical transducer is configured to modulate a third wavelength and the fourth electrical-to-optical transducer is configured to modulate a fourth wavelength; a second waveguide portion configured to disperse the second optical signal or to introduce a wavelength-dependent time delay in the second optical signal, wherein the second waveguide portion is comprised in the second waveguide and arranged after the at least third and fourth electrical-to-optical transducers; a second optical-to-electrical transducer arranged at a second output of the second waveguide, and wherein the second optical-to-electrical transducer is configured to output a second electrical output signal based on the second optical signal.

The second waveguide may have at least one property or any combinations of properties as described herein regarding the first waveguide. The second electrical output signal can have at least one property or any combinations of properties as described herein regarding the first electrical output signal. The secondary electrical-to-optical transducer may have at least one property or any combinations of properties as described herein regarding the primary electrical-to-optical transducer. The second light source can be the first light source. The first wavelength can have the same wavelength than the third wavelength and/or the second wavelength may have the same wavelength than the fourth wavelength. The second optical signal may have at least one property or any combinations of properties as described herein regarding the first optical signal. The at least third and fourth electrical-to-optical transducer can have at least one property or any combinations of properties as described herein regarding the at least first and second electrical-to-optical transducer.

The digital optical computing processing unit may further comprise a splitter configured to split a light source such as the first optical signal and the second optical signal can be generated from the light source. In embodiments, the light source may be configured to provide an optical signal to the first and the second waveguide, wherein the optical signal is the first optical signal and/or the second optical signal. In embodiments, this would save additional light source when parallelizing multiple waveguides on the same digital optical computing processing unit.

In embodiments, the second light source can be the first light source.

The at least fourth, fifth and sixth electrical digital signals may have at least one property or any combinations of properties as described herein regarding the at least first, second and third electrical digital signals. The second waveguide portion can have at least one property or any combinations of properties as described herein regarding the first waveguide portion.

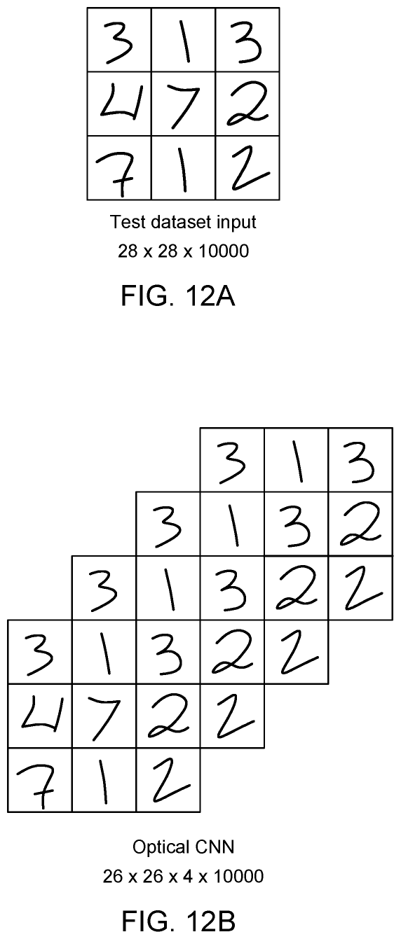

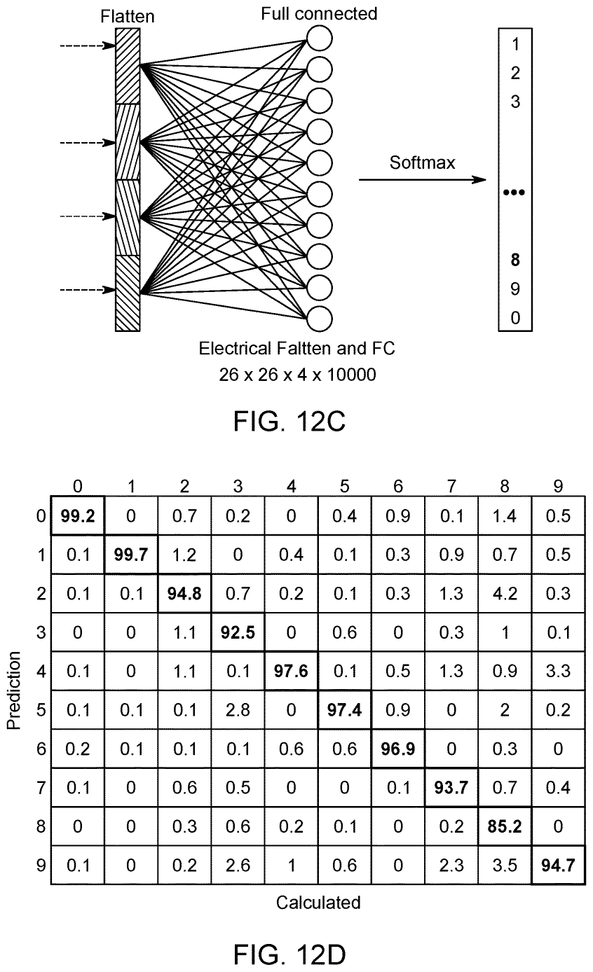

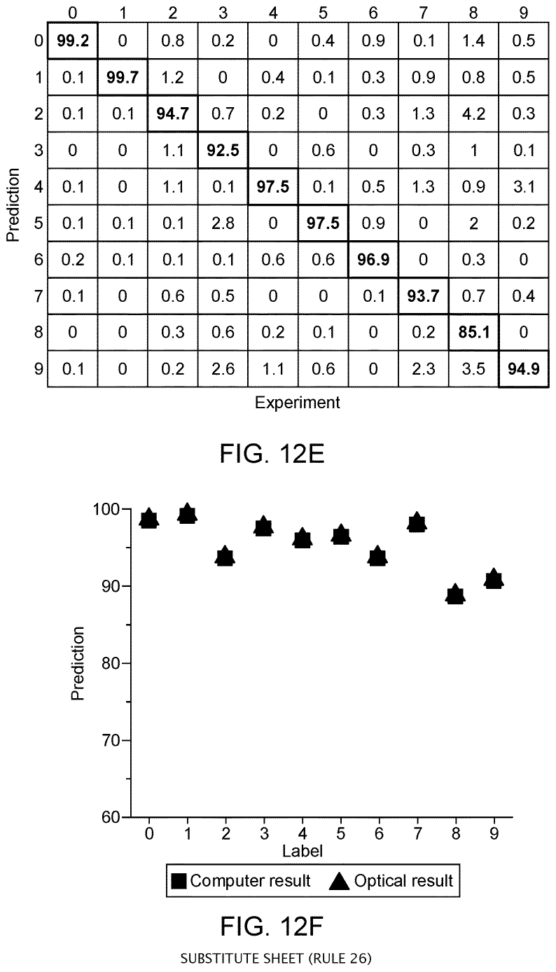

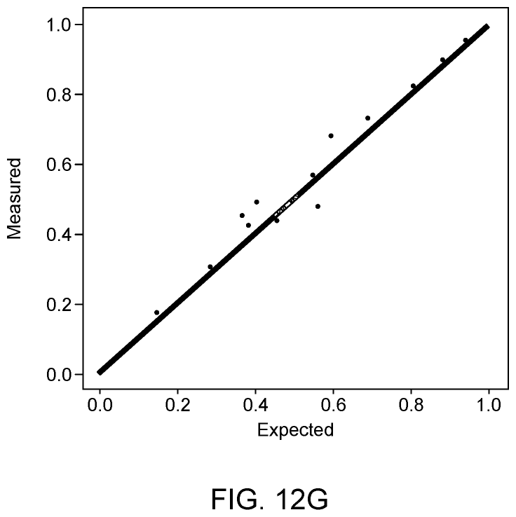

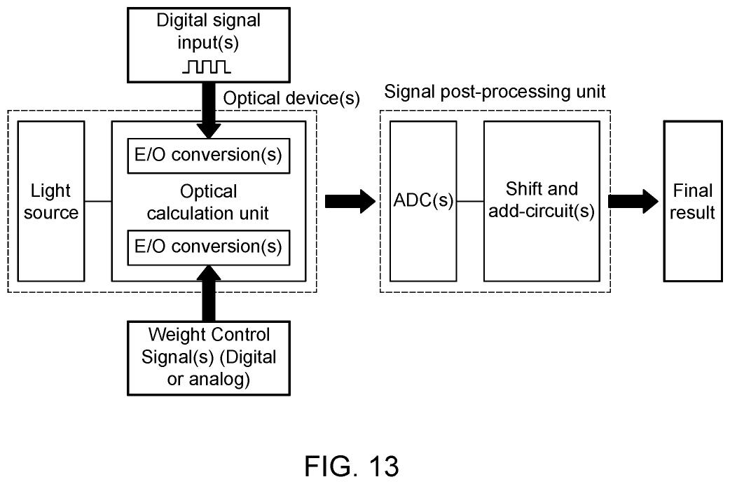

FIG. 12A-G show a modified national institute of standards and technology (MNIST) dataset validation with the digital optical processing unit. In order to evaluate the accuracy of the digital optical processing unit architecture, a handwriting recognition and image classification task is performed. In embodiments, MNIST task is a tool for verifying image recognition. The task is to distinguish 10 handwritten digits for classification. The model is pre-trained, such as the kernel matrix is known and implemented in the digital optical processing unit. FIG. 12A shows the 10,000 images of the handwritten digital MNIST test dataset used to perform the convolutional layer processing, with each image having a pixel resolution of 28×28. The result of the processing of the images is shown in FIG. 12B, where the pixel resolution is down to 26×26, because of the stride step of the convolution. Four 3×3 kernel matrixes are used in this example, which gives 26×26×4 pixel matrixes of 10,000 images. The remaining networks is processed with electronic hardware as shown in FIG. 12C, where decisions are made. The results are then compared with the results obtained from a processing unit, such as a computer. The results are substantially equivalent in each prediction classification as shown in FIGS. 12D-E. The deviation is on the order of one in a thousand. The diagonal prediction accuracy data are extracted and compared, as shown in FIG. 12F, and is substantially identical. FIG. 12G shows the comparison between standard expected result and the digital optical processing unit calculation result. The resulting distribution converge linearly, with only individual points distributed outside. These results may demonstrate that the precision of the digital optical processing unit is comparable with that of a processing unit, such as a computer.

In one aspect, the present disclosure may relate to a method for a hybrid optical-electrical convolution between an input data matrix of size i×j and kernel matrix of size i×j comprising the steps of providing an optical signal having i×j different optical carriers, such as i×j different wavelengths; modulating the optical signal with i×j digital data signals, such that an nth of the i×j optical carriers is modulated with an nth of the i×j digital data signals, wherein the i×j digital data signals are a digital representation of i×j elements of the input data matrix; modulating the optical signal with the kernel matrix such that the kernel matrix applies weights on the i×j optical carriers; summing the i×j optical carriers in a wavelength-independent optical-to-electrical transducer on a per symbol level thereby generating an electrical output signal, wherein the electrical output signal represents the convolution between the input data matrix and the kernel matrix.

The optical-to-electrical transducer may be wavelength-independent. The optical-to-electrical transducer may be configured to optically convert all the wavelengths from an optical signal passing through it to an electrical signal, with the same modulation data.

In an embodiment, i is larger than j, lower than j, or equal to j.

The i×j different wavelengths may be equally spaced between each other. The i×j different wavelengths can have different corresponding frequencies, and the different frequencies can define a frequency comb.

The i×j digital data signals can be binary words.

The input data matrix can contain coded elements from an image, where the coded elements may be digital representation of pixels. The digital representation of pixels can be a binary code. In embodiments, the binary code may be a 2-bit binary code, a 4-bit binary code, a 8-bit binary code, a 16-bit binary code, a 32-bit binary code, or a 64-bit binary code.

The kernel matrix may be a convolution matrix, where the convolution matrix can be a matrix used for blurring, sharpening, embossing or edge detecting. In embodiments, the kernel matrix can be a 3×3 matrix, a 4×4, a 6×6, or a 16×16 matrix.

The optical signal can be generated by a laser source. The laser source may be configured to generate at least two optical wavelengths.

The i×j digital data signals can comprise at least two symbols. In embodiments, the i×j digital data signals may be binary data signals, or multi-level digital data signals, such as PAM signals. The PAM signals may comprise 2, 4, or more levels. Binary data signals may be binary signals containing data.

The weights can be comprised between −1 and 1. i×j digital data, the weights can be any values comprised between −1 and 1, including −1 and 1.

The wavelength-independent optical-to-electrical transducer can be a photodiode. i×j digital data, the wavelength-independent optical-to-electrical transducer can be any type of photodetector.

The method for a hybrid optical-electrical convolution between an input data matrix of size i×j and kernel matrix of size i×j can be carried out by the optical digital processing unit configured to perform analogue-digital convolutions as described herein.

In another aspect, the present disclosure may relate to a method for a hybrid optical-electrical convolution between an input data matrix of size i×j and kernel matrix of size i×j comprising the steps of providing an optical signal having i×j different optical carriers, such as i×j different wavelengths; modulating the optical signal with i×j digital data signals, wherein the i×j digital data signals are a digital representation of the i×j elements of the input data matrix, and such that each of the i×j optical carriers is modulated with the i×j digital data signals, thereby obtaining i×j optical data signals; providing a time delay between the i×j optical data signals, such that each of the i×j optical data signals are delayed in time between each other; modulating the i×j optical data signals with the kernel matrix such that an nth element of the kernel matrix applies a nth weight on a nth of the i×j optical carriers; summing the i×j optical carriers in a wavelength-independent optical-to-electrical transducer on a per symbol level thereby generating an electrical output signal, wherein the electrical output signal represents the convolution between the input data matrix and the kernel matrix.

The optical-to-electrical transducer may be wavelength-independent. The optical-to-electrical transducer may be configured to modulate all the wavelengths from an optical signal passing through it, with the same modulation data.

The i×j digital data signals can be binary words.

In embodiments, i can be larger than j, lower than j, or equal to j.

The i×j different wavelengths can be equally spaced between each other. The i×j different wavelengths may have different corresponding frequencies, and the different frequencies can define a frequency comb.

The time delay may be relative to a symbol data rate. The j symbols and/or the k symbols may modulate the i optical carriers at the symbol data rate. The symbol data rate can be the inverse of a symbol data period. In embodiments, the time delay can be 100% of the symbol data period, comprised between 100% and 110% of the symbol data period, comprised between 100% and 150% of the symbol data period, or comprised between 100% and 200% of the symbol data period.

The input data matrix can contain coded elements from an image. The coded elements may be digital representation of pixels. The digital representation of pixels can be a binary code. In embodiments, the binary code may be a 2-bit binary code, a 4-bit binary code, a 8-bit binary code, a 16-bit binary code, a 32-bit binary code, or a 64-bit binary code.

The kernel matrix can be a convolution matrix, wherein the convolution matrix may be a matrix used for blurring, sharpening, embossing or edge detecting. In embodiments, the kernal matrix can be a 3×3 matrix, a 4×4, a 5×5, a 6×6 matrix, or a 16×16 matrix.

The optical signal may be generated by a laser source. The laser source can be configured to generate at least two optical wavelengths.

The i×j digital data signals may comprise at least two symbols. In embodiments, the l×j digital data signals can be binary data signals, or multi-level digital data signals, such as PAM signals. The PAM signals may comprise 2, 4, or more levels. Binary data signals may be binary signals containing data.

The weights may be comprised between −1 and 1. In embodiments, the weights can be any values comprised between −1 and 1, including −1 and 1.

The wavelength-independent optical-to-electrical transducer can be a photodiode. In embodiments, the wavelength-independent optical-to-electrical transducer can be any type of photodetector.

The method for a hybrid optical-electrical convolution between an input data matrix of size i×j and kernel matrix of size i×j may be carried out by the digital optical processing unit configured to perform analogue-digital continuous convolutions as described herein.

In another aspect, the present disclosure may relate to a method for hybrid optical-electrical multiplication of a first digital signal comprising j symbols with a second digital signal comprising k symbols, comprising the steps of providing an optical signal having i different optical carriers, such as i different wavelengths and wherein i is larger or equal than j, and wherein j is larger or equal than k; modulating the optical signal with the first digital signal, such that each of the i optical carriers is modulated with the first digital signal, thereby defining i optical digital signals; modulating each of the i optical digital signals with a nth of the k symbols on a nth of the i optical carriers; providing a time delay between the i optical digital signals, such that each of the i optical digital signals are separated in time; summing the i optical carriers in a wavelength-independent optical-to-electrical transducer on a per symbol level thereby generating an electrical output signal, wherein the electrical output signal represents the multiplication between the first digital signal and the second digital signal.

The optical-to-electrical transducer may be wavelength-independent. The optical-to-electrical transducer may be configured to optically convert all the wavelengths from an optical signal passing through it to an electrical signal, with the same modulation data.

The i different wavelengths can be equally spaced between each other. The i different wavelengths may have different corresponding frequencies, and the different frequencies can define a frequency comb.

The time delay may be relative to a symbol data rate. The j symbols and/or the k symbols can modulate the i optical carriers at the symbol data rate. The symbol data rate may be the inverse of a symbol data period. In embodiments, the time delay can be 100% of the symbol data period, comprised between 90% and 110% of the symbol data period, comprised between 50% and 150% of the symbol data period, or comprised between 50% and 200% of the symbol data period.

The first digital signal and/or the second digital signal can be a multi-level digital signal or a binary signal. Each of the i optical digital signals can be multi-level digital signals or binary signals. The optical signal may be generated by a laser source. The laser source can be configured to generate at least two optical wavelengths.

The first digital signal can be a multiplier and the second digital signal can be a multiplicand. The first digital signal can be a multiplicand and the second digital signal can be a multiplier. The j symbols and/or the k symbols can be multi-level symbols or bits, which may be two-level symbols.

The wavelength-independent optical-to-electrical transducer may be a photodiode. In embodiments, the wavelength-independent optical-to-electrical transducer can be any type of photodetector.

The method for hybrid optical-electrical multiplication can be carried out by the digital optical processing unit configured to perform digital-digital multiplications as described herein.

### Further Details

1. A digital optical computing processing unit configured to perform analogue-digital convolutions by processing at least a first and a second electrical digital signal and a first optical signal comprising at least two wavelengths, the digital optical computing processing unit comprising:
   a first waveguide for carrying the first optical signal;
   at least a first and a second electrical-to-optical transducer comprised in the first waveguide, configured to be biased by at least a first and a second weight, wherein the at least first and second electrical digital signals modulate the first optical signal in the at least first and second electrical-to-optical transducers, respectively, and wherein the first electrical-to-optical transducer is configured to modulate a first wavelength and the second electrical-to-optical transducer is configured to modulate a second wavelength.
2. The digital optical computing processing unit according to item 1, further comprising a light source configured to deliver a first optical signal comprising at least two wavelengths to the first waveguide.
3. The digital optical computing processing unit according to any one of items 1-2, further comprising a first optical-to-electrical transducer arranged at a first output of the first waveguide, and wherein the first optical-to-electrical transducer is configured to output a first electrical output signal based on the first optical signal.
4. The digital optical computing processing unit according to any one of items 1-3, wherein the at least first and second electrical digital signals represent at least a first and second inputs, encoded in a binary word.
5. The digital optical computing processing unit according to any one of items 1-4, wherein the at least first and second electrical-to-optical transducers are arranged in series.
6. A digital optical computing processing unit configured to perform analogue-digital continuous convolutions by processing at least a first, a second and a third electrical digital signal and a first optical signal comprising the at least two wavelengths, the digital optical computing processing unit comprising:
   a first waveguide for carrying the first optical signal;
   a primary electrical-to-optical transducer comprised in the first waveguide, wherein the first optical signal is modulated by the at least first electrical digital signal in the primary electrical-to-optical transducer;
   at least a first and a second electrical-to-optical transducer comprised in the first waveguide, and further arranged in series with the primary electrical-to-optical transducer, wherein the at least first and second electrical-to-optical transducer are configured to be biased by at least a first and a second weight, and wherein the at least first and second electrical digital signals modulate the first optical signal in the at least first and second electrical-to-optical transducers, respectively, and wherein the first electrical-to-optical transducer is configured to modulate a first wavelength and the second electrical-to-optical transducer is configured to modulate a second wavelength;
   a first waveguide portion configured to introduce a wavelength-dependent time delay in the first optical signal.
7. The digital optical computing processing unit according to item 6, further comprising a light source configured to deliver a first optical signal comprising at least two wavelengths to the first waveguide.
8. The digital optical computing processing unit according to any one of items 6-7, further comprising a first optical-to-electrical transducer arranged at a first output of the first waveguide, and wherein the first optical-to-electrical transducer is configured to output a first electrical output signal based on the first optical signal.
9. The digital optical computing processing unit according to any one of items 6-8, wherein the first waveguide portion is comprised in the first waveguide and arranged before the at least first and second electrical-to-optical transducers and after the primary electrical-to-optical transducer.
10. The digital optical computing processing unit according to any one of items 6-9, wherein the at least first and second electrical-to-optical transducers are arranged in series.
11. A digital optical computing processing unit configured to perform digital-digital multiplications by processing at least a multiplier and a multiplicand, wherein the multiplicand comprises at least a first electrical digital signal, and the multiplier comprises at least a second and a third electrical digital signal, and a first optical signal comprising at least two wavelengths, the digital optical computing processing unit comprising:
   a first waveguide for carrying the first optical signal;
   a primary electrical-to-optical transducer comprised in the first waveguide, wherein the first optical signal is modulated by the at least first electrical digital signal in the primary electrical-to-optical transducer;
   at least a first and a second electrical-to-optical transducer comprised in the first waveguide, and further arranged in series with the primary electrical-to-optical transducer, wherein the at least second and third electrical digital signals modulate the first optical signal in the at least first and second electrical-to-optical transducers, respectively, and wherein the first electrical-to-optical transducer is configured to modulate a first wavelength and the second electrical-to-optical transducer is configured to modulate a second wavelength;
   a first waveguide portion configured to introduce a wavelength-dependent time delay in the first optical signal.
12. The digital optical computing processing unit according to item 11, wherein the at least first and second electrical-to-optical transducer are arranged in series.
13. The digital optical computing processing unit according to item 11, further comprising a light source configured to deliver a first optical signal comprising at least two wavelengths to the first waveguide.
14. The digital optical computing processing unit according to any one of items 11-13, further comprising a first optical-to-electrical transducer arranged at a first output of the first waveguide, and wherein the first optical-to-electrical transducer is configured to output a first electrical output signal based on the first optical signal.
15. The digital optical computing processing unit according to any one of items 11-14, wherein the at least first electrical digital signal is encoded in a binary word.
16. The digital optical computing processing unit according to any one of items 11-15, wherein the at least second and third electrical digital signals are respectively at least a first and a second bit of the multiplier.
17. The digital optical computing processing unit according to any one of items 11-16, wherein the wavelength-dependent time delay is a time delay between the at least two wavelengths.
18. The digital optical computing processing unit according to any one of items 11-17, wherein the waveguide portion is comprised in the first waveguide and arranged after the primary electrical-to-optical transducer.
19. The digital optical computing processing unit according to any one of items 11-18, wherein the waveguide portion is comprised in the first waveguide and arranged after the at least first and second electrical-to-optical transducers.
20. The digital optical computing processing unit according to any one of items 11-19, wherein the at least first and second electrical-to-optical transducer are configured to be biased by the at least second and third electrical digital signals, thereby modulating the first optical signal with the at least second and third electrical digital signals.
21. The digital optical computing processing unit according to any one of items 1-20, wherein the first electrical output signal is a first electrical digital output signal.
22. The digital optical computing processing unit according to any one of items 1-21, wherein the digital optical computing processing unit further comprises at least one signal processing unit configured to convert the first electrical digital output signal to a binary signal.
23. The digital optical computing processing unit according to any one of items 1-22, wherein an output of the first electrical-to-optical transducer is connected to an input of the second electrical-to-optical transducer.
24. The digital optical computing processing unit according to any one of items 1-23, wherein the primary electrical-to-optical transducer is wavelength-independent.
25. The digital optical computing processing unit according to any one of items 1-24, wherein the primary electrical-to-optical transducer is a Mach-Zehnder modulator (MZM) or an electro-absorption modulator (EAM).
26. The digital optical computing processing unit according to any one of items 1-25, wherein the at least first and second electrical-to-optical transducers are wavelength-dependent.
27. The digital optical computing processing unit according to any one of the preceding items, wherein the at least first and second electrical-to-optical transducers are configured to modulate a range of wavelengths.
28. The digital optical computing processing unit according to any one of the preceding items, wherein the at least first and second electrical-to-optical transducers are configured to have a passband bandwidth comprised between 5 and 100 GHz, between 10 and 70 GHz, between 20 and 60 GHz, or between 30 and 50 GHz.
29. The digital optical computing processing unit according to any one of the preceding items, wherein the at least first and second electrical-to-optical transducers are at least a first and a second micro-ring resonator or at least a first and a second cascaded Mach-Zehnder.
30. The digital optical computing processing unit according to item 29, wherein the at least first and second micro-ring resonators comprise at least a first and a second heater modulator.
31. The digital optical computing processing unit according to any one of the preceding items, wherein the at least first and second weights are normalized and comprised between −1 and +1.
32. The digital optical computing processing unit according to any one of the preceding items, wherein the at least first and second weights are represented by at least a first and a second electrical digital weight signal.
33. The digital optical computing processing unit according to any one of the preceding items, wherein the digital optical computing processing unit further comprises a digital-to-analogue converter (DAC) configured to convert the at least first and second electrical digital weight signals into at least a first and a second electrical analogue weight signals.
34. The digital optical computing processing unit according to item 33, wherein the at least first and second electrical analogue weight signals are at least a first and a second bias signal.
35. The digital optical computing processing unit according to any one of the preceding items, wherein the at least first and second bias signals are configured to bias the at least first and second heater modulators of the at least first and second electrical-to-optical transducers, respectively.
36. The digital optical computing processing unit according to any one of the preceding items, wherein the at least first and second heater modulators are configured to modulate at least a first and a second amplitude of the first and the second wavelengths, respectively, of the first optical signal.
37. The digital optical computing processing unit according to any one of the preceding items, wherein the at least first and second weights are weights of a weight matrix of a neural network.
38. The digital optical computing processing unit according to any one of items 1-37, wherein the at least first, second and third electrical digital signals represents at least a first and a second pixel information of an image.
39. The digital optical computing processing unit according to any one of items 1-38, wherein the at least first, second and/or third electrical digital signal comprises at least one symbol.
40. The digital optical computing processing unit according to item 39, wherein the at least one symbol is processed with a symbol data rate into the digital optical computing processing unit.
41. The digital optical computing processing unit according to any one of items 1-40, wherein the first waveguide portion is a dispersive waveguide portion.
42. The digital optical computing processing unit according to item 41, wherein the dispersive waveguide portion is a photonic crystal or a chirped Bragg grating.
43. The digital optical computing processing unit according to any one of items 41-42, wherein the dispersive waveguide portion is configured to generate a time delay between the at least two wavelengths.
44. The digital optical computing processing unit according to any one of preceding items, wherein the time delay is relative to a symbol data period, wherein the symbol data period is the inverse of the symbol data rate.
45. The digital optical computing processing unit according to item 43 or 44, wherein the time delay is 100% of the symbol data period, comprised between 90% and 110% of the symbol data period, comprised between 50% and 150% of the symbol data period, or comprised between 50% and 200% of the symbol data period.
46. The digital optical computing processing unit according to any one of preceding items, wherein the light source is a laser source.
47. The digital optical computing processing unit according to any one of the preceding items, wherein the first optical signal comprises at least two wavelengths.
48. The digital optical computing processing unit according to any one of the preceding items, wherein the digital optical computing processing unit further comprises a phase modulator.
49. The digital optical computing processing unit according to item 48, wherein the phase modulator is configured to generate a frequency comb light source.
50. The digital optical computing processing unit according to any one of the preceding items, wherein the at least two wavelengths are separated from one another by a frequency spacing.
51. The digital optical computing processing unit according to item 50, wherein the frequency spacing is a comb frequency spacing.
52. The digital optical computing processing unit according to any one of the preceding items, wherein the at least first, second and third electrical digital signal are multi-level digital signals and/or binary signals.
53. The digital optical computing processing unit according to any one of the preceding items, wherein the digital optical computing processing unit further comprises a carrier wave generator.
54. The digital optical computing processing unit according to item 53, wherein the carrier wave generator is configured to generate at least one carrier wave.
55. The digital optical computing processing unit according to item 54, wherein each one of the at least one carrier wave has an oscillating frequency.
56. The digital optical computing processing unit according to item 55, wherein the oscillating frequency is comprised between 1 Hz and a maximum oscillating frequency.
57. The digital optical computing processing unit according to item 53, wherein the carrier wave generator is an electronic oscillator, such as a feedback oscillator or a negative-resistance oscillator.
58. The digital optical computing processing unit according to any one of the preceding items, wherein the at least first, second and third electrical digital signals are modulated in quadrature or orthogonal between each other.
59. The digital optical computing processing unit according to any one of the preceding items, wherein each of the at least first, second and third electrical digital signals are modulated by one of the at least one carrier wave.
60. The digital optical computing processing unit according to any one of the preceding items, wherein the digital optical computing processing unit further comprises at least one digital-to-analogue converter, wherein the at least one digital-to-analogue converter is configured to convert the at least first, second and third electrical digital signals into at least a first, a second and a third electrical analogue signals.
61. The digital optical computing processing unit according to any one of the preceding items, wherein the at least first, second and third electrical analogue signals are modulated by the at least one carrier wave, thereby generating at least a first, a second and a third carrier-modulated electrical signals.
62. The digital optical computing processing unit according to item 61, wherein the at least first, second and third carrier-modulated electrical signals are modulated in quadrature or orthogonal between each other.
63. The digital optical computing processing unit according to any one of the preceding items, wherein the digital optical computing processing unit further comprises an IQ modulation system.
64. The digital optical computing processing unit according to item 63, wherein the IQ modulation system is configured to modulate the at least first, second and third carrier-modulated electrical signals in quadrature or orthogonal between each other.
65. The digital optical computing processing unit according to any one of the preceding items, wherein the first electrical output signal is modulated according to a quadrature-amplitude modulation (QAM).
66. The digital optical computing processing unit according to item 65, wherein the quadrature-amplitude modulation is a quadrature-phase-shift-keying (QPSK) modulation, a 8-QAM, a 16-QAM, a 32-QAM, a 64-QAM, a 128-QAM, a 256-QAM, a 512-QAM, or 2^{N}-QAM, where N is an integer.
67. The digital optical computing processing unit according to any one of the preceding items, wherein the first electrical output signal is modulated by the at least one carrier wave.
68. The digital optical computing processing unit according to any one of the preceding items, wherein the digital optical computing processing unit further comprises an IQ demodulation system.
69. The digital optical computing processing unit according to item 68, wherein the IQ demodulation system is configured to demodulate the first electrical output signal into at least a first, a second and a third electrical digital output signals.
70. The digital optical computing processing unit according to any one of the preceding items, wherein the at least one signal processing unit comprises an analogue-to-digital converter (ADC) configured to convert the first electrical output signal into a first electrical digital output signal.
71. The digital optical computing processing unit according to any one of the preceding items, wherein the at least one signal processing unit further comprises digital signal processing filters and/or analogue or digital equalizers.
72. The digital optical computing processing unit according to any one of the preceding items, wherein the at least one signal processing unit further comprises an electrical signal processing unit, wherein the electrical signal processing unit comprises at least one multiplier and at least one full-adder.
73. The digital optical computing processing unit according to any one of the preceding items, wherein the digital optical computing processing unit further comprises a look-up table (LUT).
74. The digital optical computing processing unit according to any one of the preceding items, wherein the LUT is configured to store the at least first and second weights.
75. The digital optical computing processing unit according to any one of items 71-74, wherein the LUT is implemented in a field-programmable gate array (FPGA).
76. The digital optical computing processing unit according to any one of the preceding items, wherein the LUT is configured to match the at least first and second weights with at least a first and a second normalized weight value.
77. The digital optical computing processing unit according to item 76, wherein the at least first and second normalized weight values are distributed in between −1 and 1, equally distributed in between −1 and 1, or equally distributed in between 0 and 1.
78. The digital optical computing processing unit according to any one of the preceding items, wherein the digital optical computing processing unit is configured for further processing at least a fourth and a fifth electrical digital signals and a second optical signal comprising at least two wavelengths, the digital optical computing processing unit further comprises:
   a second waveguide for carrying the second optical signal;
   at least a third and a fourth electrical-to-optical transducer comprised in the second waveguide, configured to be biased by at least a third and a fourth weight, wherein the at least fourth and fifth electrical digital signals modulate the second optical signal in the at least third and fourth electrical-to-optical transducers, respectively, and wherein the third electrical-to-optical transducer is configured to modulate a third wavelength and the fourth electrical-to-optical transducer is configured to modulate a fourth wavelength.
79. The digital optical computing processing unit according to item 78, wherein the at least third and fourth electrical-to-optical transducer are arranged in series.
80. The digital optical computing processing unit according to item 78, further comprising a second light source, configured to deliver a second optical signal comprising at least two wavelengths to the second waveguide;
81. The digital optical computing processing unit according to item 78, further comprising a second optical-to-electrical transducer arranged at a second output of the second waveguide, and wherein the second optical-to-electrical transducer is configured to output a second electrical output signal based on the second optical signal.
82. The digital optical computing processing unit according to any one of the preceding items, wherein the digital optical computing processing unit is configured for further processing at least a fourth, a fifth and a sixth electrical digital signals and a second optical signal comprising at least two wavelengths, the digital optical computing processing unit further comprises:
   a second waveguide for carrying the second optical signal;
   a secondary electrical-to-optical transducer comprised in the second waveguide, wherein the second optical signal is modulated by the at least fourth electrical digital signal in the secondary electrical-to-optical transducer;
   at least a third and a fourth electrical-to-optical transducer comprised in the second waveguide, and further arranged in series with the secondary electrical-to-optical transducer, wherein the at least third and fourth electrical-to-optical transducers are configured to be biased by at least a third and a fourth weight, wherein the at least fifth and sixth electrical digital signals modulate the second optical signal in the at least third and fourth electrical-to-optical transducers, respectively, and wherein the third electrical-to-optical transducer is configured to modulate a third wavelength and the fourth electrical-to-optical transducer is configured to modulate a fourth wavelength;
   a second waveguide portion configured to introduce a wavelength-dependent time delay in the second optical signal.
83. The digital optical computing processing unit according to item 82, wherein the at least third and fourth electrical-to-optical transducer are arranged in series.
84. The digital optical computing processing unit according to item 82, further comprising a second light source, configured to deliver a second optical signal comprising at least two wavelengths to the second waveguide.
85. The digital optical computing processing unit according to item 82, further comprising a second optical-to-electrical transducer arranged at a second output of the second waveguide, and wherein the second optical-to-electrical transducer is configured to output a second electrical output signal based on the second optical signal.
86. The digital optical computing processing unit according to any of the preceding items, wherein the digital optical computing processing unit is configured for further processing at least a fourth, a fifth and a sixth electrical digital signals and a second optical comprising at least two wavelengths, the digital optical computing processing unit further comprises:
   a second waveguide for carrying the second optical signal;
   a secondary electrical-to-optical transducer comprised in the second waveguide, wherein the second optical signal is modulated by the at least fourth electrical digital signal in the secondary electrical-to-optical transducer;
   at least a third and a fourth electrical-to-optical transducer comprised in the second waveguide, and further arranged in series with the secondary electrical-to-optical transducer, wherein the at least third and fourth electrical-to-optical transducers are configured to be biased by at least a third and a fourth weight, wherein the at least third and fourth electrical digital signals modulate the second optical signal in the at least third and fourth electrical-to-optical transducers, respectively, and wherein the third electrical-to-optical transducer is configured to modulate a third wavelength and the fourth electrical-to-optical transducer is configured to modulate a fourth wavelength;
   a second waveguide portion configured to introduce a wavelength-dependent time delay in the second optical signal.
87. The digital optical computing processing unit according to item 86, wherein the at least third and fourth electrical-to-optical transducer are arranged in series.
88. The digital optical computing processing unit according to item 86, further comprising a second light source configured to deliver a second optical signal comprising at least two wavelengths to the second waveguide.
89. The digital optical computing processing unit according to item 86, further comprising a second optical-to-electrical transducer arranged at a second output of the second waveguide, and wherein the second optical-to-electrical transducer is configured to output a second electrical output signal based on the second optical signal.
90. The digital optical computing processing unit according to any one of the preceding items, wherein the second waveguide has at least one property or any combinations of properties as presented regarding the first waveguide.
91. The digital optical computing processing unit according to any one of the preceding items, wherein the second electrical output signal has at least one property or any combinations of properties as presented regarding the first electrical output signal.
92. The digital optical computing processing unit according to any one of the preceding items, wherein the secondary electrical-to-optical transducer has at least one property or any combinations of properties as presented regarding the primary electrical-to-optical transducer.
93. The digital optical computing processing unit according to any one of the preceding items, wherein the second light source is the first light source.
94. The digital optical computing processing unit according to any one of the preceding items, wherein the first wavelength has the same wavelength than the third wavelength and/or the second wavelength has the same wavelength than the fourth wavelength.
95. The digital optical computing processing unit according to any one of the preceding items, wherein the second optical signal has at least one property or any combinations of properties as presented regarding the first optical signal.
96. The digital optical computing processing unit according to any one of the preceding items, wherein the at least third and fourth electrical-to-optical transducer has at least one property or any combinations of properties as presented regarding the at least first and second electrical-to-optical transducer.
97. The digital optical computing processing unit according to any one of the preceding items, wherein the digital optical computing processing unit further comprises a splitter configured to split a light source such as the first optical signal and the second optical signal is generated from the light source.
98. The digital optical computing processing unit according to any one of the preceding items, wherein the second light source is the first light source.
99. The digital optical computing processing unit according to any one of the preceding items, wherein the at least fourth, fifth and sixth electrical digital signals have at least one property or any combinations of properties as presented regarding the at least first, second and third electrical digital signals.
100. The digital optical computing processing unit according to any one of the preceding items, wherein the second waveguide portion has at least one property or any combinations of properties as presented regarding the first second waveguide portion.
101. A method for a hybrid optical-electrical convolution between an input data matrix of size i×j and kernel matrix of size i×j comprising the steps of:
   providing an optical signal having i×j different optical carriers, such as i×j different wavelengths;
   modulating the optical signal with i×j digital data signals, such that an nth of the i×j optical carriers is modulated with an nth of the i×j digital data signals, wherein the i×j digital data signals are a digital representation of i×j elements of the input data matrix;
   modulating the optical signal with the kernel matrix such that the kernel matrix applies weights on the i×j optical carriers;
   summing the i×j optical carriers in an optical-to-electrical transducer on a per symbol level thereby generating an electrical output signal, wherein the electrical output signal represents the convolution between the input data matrix and the kernel matrix.
102. The method according to item 101, wherein the optical-to-electrical transducer is wavelength-independent.
103. The method according to any one of items 101-102, wherein i is larger than j, lower than j, or equal to j.
104. The method according to any one of items 101-103, wherein the i×j different wavelengths are equally spaced between each other.
105. The method according to any one of items 101-104, wherein the i×j different wavelengths have different corresponding frequencies, and wherein the different frequencies define a frequency comb.
106. The method according to any one of items 101-105, wherein the input data matrix contains coded elements from an image.
107. The method according to item 106, wherein the coded elements are digital representation of pixels.
108. The method according to item 107, wherein the digital representation of pixels is a binary code.
109. The method according to item 108, wherein the binary code is a 2-bit binary code, a 4-bit binary code, a 8-bit binary code, a 16-bit binary code, a 32-bit binary code, or a 64-bit binary code.
110. The method according to any one of items 101-109, wherein the kernel matrix is a convolution matrix, wherein the convolution matrix is a matrix used for blurring, sharpening, embossing or edge detecting.
111. The method according to any one of items 101-110, wherein the kernel matrix is a 3×3 matrix, a 4×4, a 6×6, or a 16×16 matrix.
112. The method according to any one of items 101-111, wherein the optical signal is generated by a laser source.
113. The method according to item 112, wherein the laser source is configured to generate at least two optical wavelengths.
114. The method according to any one of items 101-113, wherein the i×j digital data signals comprises at least two symbols.
115. The method according to any one of items 101-114, wherein the i×j digital data signals are binary data signals, or multi-level digital data signals.
116. The method according to any one of items 101-115, wherein the weights are comprised between −1 and 1.
117. The method according to any one of items 101-116, wherein the wavelength-independent optical-to-electrical transducer is a photodiode.
118. The method according to any one of items 101-117, wherein the method is carried out by the system according to items 1-100.
119. A method for a hybrid optical-electrical convolution between an input data matrix of size i×j and kernel matrix of size i×j comprising the steps of:
   providing an optical signal having i×j different optical carriers, such as i×j different wavelengths;
   modulating the optical signal with i×j digital data signals, wherein the i×j digital data signals are a digital representation of the i×j elements of the input data matrix, and such that each of the i×j optical carriers is modulated with the i×j digital data signals, thereby obtaining i×j optical data signals; providing a time delay between the i×j optical data signals, such that each of the i×j optical data signals are delayed in time between each other;
   modulating the i×j optical data signals with the kernel matrix such that an nth element of the kernel matrix applies a nth weight on a nth of the i×j optical carriers;
   summing the i×j optical carriers in an optical-to-electrical transducer on a per symbol level thereby generating an electrical output signal, wherein the electrical output signal represents the convolution between the input data matrix and the kernel matrix.
120. The method according to item 119, wherein the optical-to-electrical transducer is wavelength-independent.
121. The method according to any one of items 119-120, wherein i is larger than j, lower than j, or equal to j.
122. The method according to any one of items 119-121, wherein the i×j different wavelengths are equally spaced between each other.
123. The method according to any one of items 119-122, wherein the i×j different wavelengths have different corresponding frequencies, and wherein the different frequencies define a frequency comb.
124. The method according to any one of items 119-123, wherein the time delay is relative to a symbol data rate.
125. The method according to any one of items 119-124, wherein the j symbols and/or the k symbols modulate the i optical carriers at the symbol data rate.
126. The method according to item 125, wherein the symbol data rate is the inverse of a symbol data period.
127. The method according to any one of items 119-126, wherein the time delay is 100% of the symbol data period, comprised between 90% and 110% of the symbol data period, comprised between 50% and 150% of the symbol data period, or comprised between 50% and 200% of the symbol data period.
128. The method according to any one of items 119-127, wherein the input data matrix contains coded elements from an image.
129. The method according to any one of items 119-128, wherein the coded elements are digital representation of pixels.
130. The method according to any one of items 119-129, wherein the digital representation of pixels is a binary code.
131. The method according to item 130, wherein the binary code is a 2-bit binary code, a 4-bit binary code, a 8-bit binary code, a 16-bit binary code, a 32-bit binary code, or a 64-bit binary code.
132. The method according to any one of items 119-131, wherein the kernel matrix is a convolution matrix, wherein the convolution matrix is a matrix used for blurring, sharpening, embossing or edge detecting.
133. The method according to any one of items 119-132, wherein the kernel matrix is a 3×3 matrix, a 4×4, a 5×5, a 6×6 matrix, or a 16×16 matrix.
134. The method according to any one of items 119-133, wherein the optical signal is generated by a laser source.
135. The method according to item 134, wherein the laser source is configured to generate at least two optical wavelengths.
136. The method according to any one of items 119-135, wherein the i×j digital data signals comprises at least two symbols.
137. The method according to any one of items 119-136, wherein the i×j digital data signals are binary data signals, or multi-level digital data signals.
138. The method according to any one of items 119-137, wherein the weights are comprised between −1 and 1.
139. The method according to any one of items 119-138, wherein the wavelength-independent optical-to-electrical transducer is a photodiode.
140. The method according to any one of items 119-139, wherein the method is carried out by the system according to items 1-100.
141. A method for a hybrid optical-electrical multiplication of a first digital signal comprising j symbols with a second digital signal comprising k symbols, comprising the steps of:
   providing an optical signal having i different optical carriers, such as i different wavelengths and wherein i is larger or equal than j, and wherein j is larger or equal than k;
   modulating the optical signal with the first digital signal, such that each of the i optical carriers is modulated with the first digital signal, thereby defining i optical digital signals;
   modulating each of the i optical digital signals with a nth of the k symbols on a nth of the i optical carriers;
   providing a time delay between the i optical digital signals, such that each of the i optical digital signals are separated in time;
   summing the i optical carriers in a wavelength-independent optical-to-electrical transducer on a per symbol level thereby generating an electrical output signal, wherein the electrical output signal represents the multiplication between the first digital signal and the second digital signal.
142. The method according to item 141, wherein the optical-to-electrical transducer is wavelength-independent.
143. The method according to any one of items 141-142, wherein the i different wavelengths are equally spaced between each other.
144. The method according to any one of items 141-143, wherein the i different wavelengths have different corresponding frequencies, and wherein the different frequencies define a frequency comb.
145. The method according to any one of items 141-144, wherein the time delay is relative to a symbol data rate.
146. The method according to any one of items 141-145, wherein the j symbols and/or the k symbols modulate the i optical carriers at the symbol data rate.
147. The method according to item 146, wherein the symbol data rate is the inverse of a symbol data period.
148. The method according to any one of items 141-147, wherein the time delay is 100% of the symbol data period, comprised between 90% and 110% of the symbol data period, comprised between 50% and 150% of the symbol data period, or comprised between 50% and 200% of the symbol data period.
149. The method according to any one of items 141-148, wherein the first digital signal and/or the second digital signal is a multi-level digital signal or a binary signal.
150. The method according to any one of items 141-149, wherein each of the i optical digital signals are multi-level digital signals or binary signals.
151. The method according to any one of items 141-150, wherein the optical signal is generated by a laser source.
152. The method according to item 151, wherein the laser source is configured to generate at least two optical wavelengths.
153. The method according to any one of items 141-152, wherein the wavelength-independent optical-to-electrical transducer is a photodiode.
154. The method according to any one of items 141-153, wherein the method is carried out by the system according to items 1-100.

1-60. (canceled)

61. A digital optical computing processing unit configured to perform digital-digital multiplications by processing at least a multiplier and a multiplicand, wherein the multiplicand comprises at least a first electrical digital signal and the multiplier comprises at least a second and a third electrical digital signal, or vice versa, and a first optical signal comprising at least two wavelengths, the digital optical computing processing unit comprising:
a first waveguide for carrying the first optical signal;
a primary electrical-to-optical transducer comprised in the first waveguide, wherein the first optical signal is modulated by the at least first electrical digital signal in the primary electrical-to-optical transducer;
at least a further first and a further second electrical-to-optical transducer comprised in the first waveguide, and further arranged in series with the primary electrical-to-optical transducer, wherein the at least second and third electrical digital signals modulate the first optical signal in the at least first and second electrical-to-optical transducers, respectively, and wherein the first electrical-to-optical transducer is configured to modulate a first wavelength and the second electrical-to-optical transducer is configured to modulate a second wavelength; and
a waveguide portion configured to introduce a wavelength-dependent time delay in the first optical signal.

62. The digital optical computing processing unit according to claim 61, wherein the at least further first and further second electrical-to-optical transducers are arranged in series.

63. The digital optical computing processing unit according to claim 61, further comprising a first optical-to-electrical transducer arranged at a first output of the first waveguide, and wherein the first optical-to-electrical transducer is configured to output a first electrical output signal based on the first optical signal, and further comprising a light source configured to deliver a first optical signal comprising at least two wavelengths to the first waveguide.

64. The digital optical computing processing unit according to claim 61, wherein the at least first electrical digital signal is encoded in at least one binary word.

65. The digital optical computing processing unit according to claim 61, wherein the at least second and third electrical digital signals are respectively at least a first and a second bit of the multiplier.

66. The digital optical computing processing unit according to claim 61, wherein the wavelength-dependent time delay is a time delay between the at least two wavelengths.

67. The digital optical computing processing unit according to claim 61, wherein the waveguide portion is comprised in the first waveguide and arranged after the primary electrical-to-optical transducer.

68. The digital optical computing processing unit according to claim 61, further comprising:
a second waveguide for carrying a second optical signal comprising at least two wavelengths; and
at least a third and a fourth electrical-to-optical transducer comprised in the second waveguide, and further arranged in series with the primary electrical-to-optical transducer, wherein at least a fourth and a fifth electrical digital signal modulate the second optical signal in the at least third and fourth electrical-to-optical transducers, respectively, and wherein the third electrical-to-optical transducer is configured to modulate a third wavelength and the fourth electrical-to-optical transducer is configured to modulate a fourth wavelength.

69. The digital optical computing processing unit according to claim 61, wherein the waveguide portion is comprised in the first waveguide and arranged after the at least further first and further second electrical-to-optical transducers.

70. The digital optical computing processing unit according to claim 61, wherein the at least further first and further second electrical-to-optical transducer are configured to modulate the first optical signal with the at least second and third electrical digital signals, respectively.

71. A digital optical computing processing unit configured to perform analogue-digital convolutions by processing at least a first and a second electrical digital signal and a first optical signal comprising at least two wavelengths, the digital optical computing processing unit comprising:
a first waveguide for carrying the first optical signal;
at least a first and a second electrical-to-optical transducer comprised in the first waveguide, configured to be biased by at least a first and a second weight, wherein the at least first and second electrical digital signals modulate the first optical signal in the at least first and second electrical-to-optical transducers, respectively, and wherein the first electrical-to-optical transducer is configured to modulate a first wavelength and the second electrical-to-optical transducer is configured to modulate a second wavelength.

72. The digital optical computing processing unit according to claim 71, wherein the at least first and second electrical-to-optical transducers are arranged in series.

73. The digital optical computing processing unit according to claim 71, further comprising a first optical-to-electrical transducer arranged at a first output of the first waveguide, and wherein the first optical-to-electrical transducer is configured to output a first electrical output signal based on the first optical signal, and further comprising a light source configured to deliver the first optical signal.

74. The digital optical computing processing unit according to claim 71, wherein the digital optical computing processing unit further comprises a carrier wave generator configured to generate at least one carrier wave, wherein the at least first and second electrical digital signals are modulated in quadrature or orthogonal between each other, and wherein each of the at least first and second electrical digital signals are modulated by one of the at least one carrier wave.

75. The digital optical computing processing unit according to claim 73, wherein the first electrical output signal is modulated according to a quadrature-amplitude modulation (QAM).

76. The digital optical computing processing unit according to claim 71, wherein the digital optical computing processing unit further comprises a look-up table (LUT), and wherein the LUT is configured to store the at least first and second weights, and wherein the LUT is configured to match the at least first and second weights with at least a first and a second normalized weight value, where the at least first and second normalized weight values are equally distributed between 0 and 1.

77. A digital optical computing processing unit configured to perform analogue-digital continuous convolutions by processing at least a first, a second and a third electrical digital signal and a first optical signal comprising the at least two wavelengths, the digital optical computing processing unit comprising:
a first waveguide for carrying the first optical signal;
a primary electrical-to-optical transducer comprised in the first waveguide, wherein the first optical signal is modulated by the at least first electrical digital signal in the primary electrical-to-optical transducer;
at least a further first and a further second electrical-to-optical transducer comprised in the first waveguide, and further arranged in series with the primary electrical-to-optical transducer, wherein the at least further first and further second electrical-to-optical transducer are configured to be biased by at least a first and a second weight, and wherein the at least first and second electrical digital signals modulate the first optical signal in the at least further first and the further second electrical-to-optical transducers, respectively, and wherein the further first electrical-to-optical transducer is configured to modulate a first wavelength and the further second electrical-to-optical transducer is configured to modulate a second wavelength; and
a first waveguide portion configured to introduce a wavelength-dependent time delay in the first optical signal.

78. The digital optical computing processing unit according to claim 77, wherein the first waveguide portion is comprised in the first waveguide and arranged before the at least further first and further second electrical-to-optical transducers and after the primary electrical-to-optical transducer.

79. The digital optical computing processing unit according to claim 61, wherein the primary electrical-to-optical transducer is wavelength-independent, and wherein the further electrical-to-optical transducers are wavelength-dependent.

80. The digital optical computing processing unit according to claim 79, wherein the primary electrical-to-optical transducer is a Mach-Zehnder modulator (MZM) or an electro-absorption modulator (EAM), and wherein further electrical-to-optical transducers are micro-ring resonators or cascaded Mach-Zehnder modulators (MZM).

81. The digital optical computing processing unit according to claim 67, wherein the first waveguide portion is a dispersive waveguide portion in the form of a photonic crystal or a chirped Bragg grating.

82. The digital optical computing processing unit according to claim 67, wherein the first waveguide portion is configured to generate a time delay between the at least two wavelengths, and wherein the at least first, second and third electrical digital signals comprise at least one symbol, and wherein the at least one symbol is processed with a symbol data rate into the digital optical processing unit, and wherein the time delay is 100% of the symbol data period.

83. The digital optical computing processing unit according to claim 77, wherein the primary electrical-to-optical transducer is wavelength-independent, and wherein the further electrical-to-optical transducers are wavelength-dependent.
